(19) United States
(12) Patent Application Publication
(10) Pub. No.: US 2025/0106575 A1
(43) Pub. Date: Mar. 27, 2025

(54) COORDINATED OUTPUT OF MULTIPLE SUBWOOFERS

(71) Applicant: Sonos, Inc., Goleta, CA (US)

(72) Inventors: Adib Mehrabi, London (GB); Franck Zagala, London (GB)

(21) Appl. No.: 18/896,484

(22) Filed: Sep. 25, 2024

Related U.S. Application Data
(60) Provisional application No. 63/585,800, filed on Sep. 27, 2023.

(51) Int. Cl. H04R 29/00

(52) U.S. Cl. CPC H04R 29/001

(57) ABSTRACT

There is provided a media playback system comprising: a first playback device, a second playback device positioned adjacent to a first wall, one or more sensors carried by at least one of the first or second playback device; one or more processors; and memory storing instructions that, when executed by the one or more processors, cause the media playback system to: determine, via the one or more sensors, an acoustic path length of sound propagating from the first playback device that is reflected from the first wall toward the second playback device; determine, based on the acoustic path length, an adjustment for playback of second audio data via the second playback device with respect to playback of first audio data via the first playback device; play back the first audio data via the first playback device; and play back the second audio data via the second playback device according to the adjustment.

### CROSS-REFERENCE TO RELATED APPLICATION

This application claims the benefit of priority to U.S. Patent Application No. 63/585,800, filed Sep. 27, 2023, which is incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, examples, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with examples of the present technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partially schematic diagram of a control device.

FIG. 2A is a front isometric view of a playback device configured in accordance with examples of the present technology.

FIG. 2B is a front isometric view of the playback device of FIG. 3A without a grille.

FIG. 2C is an exploded view of the playback device of FIG. 2A.

FIG. 3A is a perspective view of a playback device configured in accordance with examples of the present technology.

FIG. 3B is a transparent view of the playback device of FIG. 3A illustrating individual transducers.

FIGS. 4A, 4B, 4C, and 4D are diagrams showing an example playback device configuration in accordance with examples of the present technology.

FIG. 5 is a diagram showing an example media playback system in accordance with examples of the present technology.

FIGS. 6A to 6D are worked examples showing audio signals associated with the media playback system of FIG. 5 in accordance with examples of the present technology.

FIG. 7 is a flow diagram of a method in accordance with examples of the present technology.

FIG. 8 is a diagram showing an example media playback system in accordance with examples of the present technology.

FIG. 9 is a block diagram showing a process for updating one or more all-pass filters in accordance with examples of the present technology.

FIGS. 10A to 10D are frequency spectra charts associated with the above methods.

The drawings are for the purpose of illustrating example examples, but those of ordinary skill in the art will understand that the technology disclosed herein is not limited to the arrangements and/or instrumentality shown in the drawings.

### DETAILED DESCRIPTION

### I. Overview

Multi-device media playback systems are increasingly common in home and office environments. The devices on offer to listeners are capable of creating powerful listening experiences both on their own and when playing back audio synchronously with other playback devices of the system. In such home or office environments, multiple playback devices may be included in rooms.

Media playback systems may implement calibration processes to tailor their output to the listening environment. In home theatre applications, the calibration process may be tailored to target an expected listener location or area. It may be desirable to reduce negative effects caused by interaction of sound with the listening environment. Negative effects may be caused by room layout and/or dimensions and/or geometry. For example, playing back low frequency audio may excite one or more room modes. In a media playback system, low-frequencies may be generated by one or more of the playback devices. A dedicated playback device may be provided for producing low frequency audio, such as a subwoofer or ‘sub’.

Room modes may occur when sound reflects off a surface and causes an interference pattern, or creates standing waves within the room. Room modes formed by low frequency sound may be considered to be more problematic because they are more distinguishable. Low frequency room modes may be more distinguishable due to the wavelengths, multiples of the wavelengths, or fractions of the wavelengths (such as a half wavelength) of the sound waves being close to the dimensions of the room (e.g., a 200 Hz sound wave may have a wavelength of approximately 1.7 m, while a 100 Hz sound wave may have a wavelength of approximately 3.4 m). Low frequency room modes may also be more sparsely distributed across the frequency axis, meaning that they are more apparent to a listener. High frequency sound may also form room modes, but the short wavelengths and the dense distribution of these room modes across the frequency range may make them less distinguishable to a listener, and therefore they may be considered to be less of a problem.

A room mode may result in unwanted variations in the audio across the room and this may cause a sound field across the room to be heterogenous. The unwanted variations may result in information forming part of the audio being played back to be altered or lost, e.g., the user hears something other than what was intended. To ensure that the audio is played back as intended, it can be an aim of a media playback system to create a homogenous sound field within a listening environment. In a homogenous sound field, spatial and spectral variation in the sound field is minimized. Thus, in a homogenous sound field, a listener has the same audio experience regardless of their location within the listening environment and regardless of the audio being played back.

Some approaches may attempt to create a homogenous sound field using two or more subwoofers or other devices playing back low frequency audio. For instance, some systems utilize two subwoofers in a home theater, and, under such an approach, audio is played across the two subwoofers with a gain reduction (e.g., −3 dB). While these scenarios may change how the low-frequency audio is distributed through the environment, there can still be some undesirable constructive or destructive interference as the outputs of the subwoofers interact with each other and the room. Accordingly, the sound field may be undesirably heterogenous.

The techniques described herein may improve the homogeneity of the sound field within a listening environment. The techniques employ compensation for positioning and phase differences between the outputs of two or more individual devices of a media playback system. The outputs of the devices may be changed to compensate for spatial variation in the sound field and/or spectral variation in the sound field. The techniques described herein may utilize considerations of the layout of the playback devices within a media playback system and/or the geometry of the listening environment. The techniques may include applying processing to an audio signal for playback by a playback device to adapt the audio signal to the listening environment and layout of the devices, and thereby influence the sound field. By applying such processing and compensation, negative and unwanted effects may be reduced. A more homogenous sound field may be achieved, and the listening experience of a listener may be improved. In some examples, the sound field may be more homogenous than the response of the individual playback devices. A more homogenous sound field may be useful for low frequency sound which may otherwise exhibit variation due to the increased likelihood of interaction with room modes.

According to an aspect of the invention, there is provided a method that may provide improved homogeneity of a sound field within a listening environment. The method involves playing back first audio data, which may be referred to as ‘first audio’, via a first playback device and playing back second audio data, which may be referred to as ‘second audio’, via a second playback device. The second audio is adjusted relative to the first audio. Further audio may be played back by further playback devices, and the further audio may also be adjusted relative to the first audio. For example, the method may include playing back third audio via a third playback device. The third audio may be adjusted relative to the first audio. The third audio may be adjusted differently to the second audio. In some examples, two playback devices may play back the first audio, and one or more further devices may play back second audio that is adjusted relative to the first audio. The first audio may be unprocessed or unchanged relative to an input audio such as a song or soundtrack. In other words, the first audio is the audio that a listener desires the playback system to recreate, and that audio is reproduced by at least one playback device. By this technique, a sound field is created by playing back to the first audio, and then further playback devices are used to adjust the sound field, for example to reduce negative effects.

The second audio may be adjusted using an adjustment. The method may include determining the adjustment for playback of at least the second audio via the second playback device. The adjustment may be for playback of at least the second audio via the second playback device relative to playback of the first audio via the first playback device. The adjustment may be determined to take account of or counteract spectral or spatial variation in the sound field. The variation in the sound field may be an expected variation, made by taking measurements of a listening environment and predicting the variation, or it may be a measured variation, such that measurements of the sound field are taken and fed back to adjust the second audio to reduce the variation.

The adjustment may be implemented according to a Controlled Acoustic Bass System (CABS) process. Using the CABS process, the output of the first playback device may be modelled as a plane wave travelling along the listening environment towards the second playback device. The plane wave may reflect off a wall adjacent to the second playback device, and the reflection of the wave may cause unwanted interference. To account for the reflection, the second audio played back by the second playback device may comprise the first audio that has been adjusted so that it is delayed and so that its polarity is changed. By changing the polarity of the first audio, the second audio represents an inverted version of the first audio. By applying a change in polarity and a delay to the first audio to provide the second audio, interference effects caused by the reflection of the wave off the wall adjacent the second playback device may be substantially negated. Accordingly, the method described herein may include an adjustment that comprises a delay. The second audio may comprise an inverted version of the first audio or an inverted portion of the first audio. The method may comprise inverting at least a portion of the first audio. The adjustment may be determined based on measurements of the listening environment.

The CABS approach described above makes use of manual measurements of the listening environment which are then used to calculate the relative adjustments. Setting up a media playback system in a home and requiring the user to perform measurements of the listening environment manually is an onerous task. The techniques described herein allow for a less onerous setup process for a listener by enabling the media playback system to perform the measurements itself. In some embodiments, one or more measurements associated with the listening environment may be determined by the media playback system, and the adjustment may be based on the determined measurements. The one or more measurements may comprise one or more dimensions of the listening environment, such as distances between two opposing walls, one or more distances between the devices, one or more distances between one or more devices and one or more features of the listening environment, or a combination of the above distances and dimensions. A combination may comprise an acoustic path length.

In some examples, an acoustic path length may be determined. The acoustic path length extends from the first playback device to the wall where the reflection may take place and back to the second playback device. The wall may be a back wall of a listening environment. A back wall may be opposite to a front wall. When using the media playback system, listeners may face the front wall. The first playback device may be positioned adjacent the front wall, and the second playback device may be positioned adjacent the back wall. The wall may therefore be defined as the wall closest to the second playback device. The acoustic path length may be defined as extending from the first playback device past the second playback device to a wall beyond the second playback device and reflecting from the wall back to the second playback device. The acoustic path length may be determined by determining a distance between the first playback device and the wall and a distance between the second playback device and the wall. The distance between the first playback device and the wall may be determined by determining a distance between the first playback device and the second playback device and by determining the distance between the second playback device and the wall. Determining the adjustment may comprise determining a delay time associated with a time-of-flight of sound propagation corresponding to the acoustic path length. Playing back the second audio may comprise delaying playback of the second audio data according to the determined delay time with respect to the playback of the first audio data via the first playback device.

In some examples, a plurality of acoustic path lengths may be determined. The plurality of acoustic path lengths may correspond to different propagation paths, such as reflections from different walls or surfaces of the listening environment. For example, in addition to the path from the first playback device to the second playback device via the wall, which may be the rear or back wall of the listening environment, an acoustic path length may be determined for at least one of: a path extending directly from the first playback device to the second playback device; a path between the first playback device and the second playback device that is reflected from a side wall of the listening environment; a path between the first playback device and the second playback device that is reflected from a front wall of the listening environment, wherein the first playback device is positioned between the front wall and the second playback device; a path between the first playback device and the second playback device that is reflected from a ceiling wall of the listening environment; a path between the first playback device and the second playback device that is reflected from a floor of the listening environment; or a path between the first playback device and the second playback device that is reflected from a plurality of different surfaces of the listening environment, such as the ceiling and a wall adjacent the second playback device. The adjustment may be determined based on one or more of the plurality of acoustic path lengths.

The media playback system may include one or more sensors, and the one or more sensors may be configured to determine the measurements on which the adjustment is to be based. The one or more sensors may be provided at one or both of the first playback device and the second playback device, and may comprise one or more microphones. Where the sensors comprise one or more microphones, a measurement may be determined by outputting audio from one of the playback devices and receiving the audio or a reflection of the audio from a boundary or other feature of the listening environment at the one or more microphones. This audio may be referred to as third audio, a third audio signal, or third audio data to distinguish from the first and second audio played back by the first and second playback devices as part of the above method. The measurement may be determined based on a time-of-flight of the signal. The time-of-flight may be determined by determining a time at which the audio was emitted or output and determining a time at which the audio was received at the one or more microphones. The playback devices may be time-synchronized so that the determined times can be compared.

In an example, the second playback device may comprise a microphone. The first playback device may be configured to output audio. The audio may comprise a sweep signal, and/or may comprise noise, such as white or pink noise. The second playback device may receive the audio and/or a reflection of the audio at its microphone. The second playback device, first playback device, or a network device connected to the first and second playback devices may be configured to determine the time-of-flight of the signal between the first and second playback device, and therefore a measurement based on the signal. The first and second playback devices may be time-synchronized, so that the time at which the first playback device emits the audio and the time at which the second playback device records the audio may be comparable. The second playback device may be configured to output further audio and to receive a reflection of that audio from a wall of the listening environment. Based on the received reflection, the second playback device may determine a time-of-flight of the audio it outputs, and therefore determine a distance of the second playback device from the wall. The wall may be a wall closest to the second playback device. The wall may be a back wall of the listening environment in which the media playback system is provided. The wall may be a side wall closest to the second playback device.

The one or more sensors may comprise a camera or other sensor, such as a LiDAR sensor, of a control device, such as a mobile device or tablet. A user may scan the listening environment to determine the measurements using their control device. The user may be prompted to initiate the scan of the listening environment during setup of the media playback system. The system may alternatively or additionally be configured to identify that one or more of the playback devices in the media playback system has moved and to prompt the user to re-perform the scan of the listening environment. The system may determine that a playback device has moved based on one or more accelerometers in the device or based on measurements made by one or more microphones of one of the playback devices.

Where further playback devices are provided, the method may include determining further adjustments. In an example where the media playback system comprises a third playback device and a fourth playback device. The fourth playback device may be positioned adjacent a wall, such as the first wall. The method may comprise determining a second adjustment for playback of fourth audio data via the fourth playback device with respect to playback of third audio data via the third playback device and playing back the fourth audio data via the fourth playback device according to the second adjustment. The method may further comprise determining a second acoustic path length of sound propagating from the third playback device that is reflected from the first wall toward the fourth playback device, and determining the second adjustment based on the second acoustic path length. Determining the second acoustic path length may comprise determining a third distance between the third playback device and the fourth wall, and determining a fourth distance between the first wall and the fourth playback device.

In a media playback system, synchronous and seamless playback of audio data is desirable. In the CABS approach, processing is applied to the audio signal separately from the playback devices, and the separate audio signals are provided to the playback devices for playback. Accordingly, rather than processing the audio data in its entirety before providing different audio signals to a media playback system, the same audio data may be provided to each playback device and processing of the audio data may be applied locally. In other words, the second audio data may comprise the first audio data to which the adjustment has been applied, so the method may include sending the first audio data to each of two or more playback devices and applying the adjustment at at least one of the two or more playback devices. To implement this, the first playback device may comprise a first network interface and the second playback device may comprise a second network interface. The method may comprise receiving, via the first network interface, the first audio data and receiving, via the second network interface, the first audio data. The method may further comprise applying, at the second playback device, the adjustment to the first audio data, thereby to generate the second audio data.

Listening environments may be different shapes, and it may be desirable to apply the above techniques to take account of the shape of the listening environment. Through experimentation, the inventors have determined that CABS may be most effective when applied along a longest dimension of the listening environment, although in some examples applying CABS along another dimension may also be useful. The media playback system may be configured to determine a longest dimension of the listening environment and apply the adjustment to playback devices along the longest dimension. The method may therefore comprise determining that the first playback device and the second playback device are arranged along a longest horizontal dimension of the listening environment. The adjustment may be determined based on determining that the first playback device and the second playback device are arranged along the longest horizontal dimension of the listening environment. Where the media playback system comprises at least three playback devices, the method may comprise determining two or more dimensions of the listening environment and determining a longest dimension of the two or more dimensions. The method may then comprise determining at least two of the playback devices that are positioned along the longest dimension. A distance between each playback device may be determined based on one or more measurements using the one or more sensors, and it may be determined which of the distances is longest and/or which of the distances is closest to the longest dimension. In some examples, where a scan of the listening environment is performed, the scan data may be used to identify the devices that are along the longest dimension. The method may comprise determining, based on one or more measurements, a model of the listening environment, and determining the longest dimension based on the model.

While the output of a playback device, such as a subwoofer, may be modelled and therefore corrected based on the audio acting as a plane wave within the listening environment, there may be other ways to improve the homogeneity of the sound field. In examples, which may be combined with the above method or may be used separately, second audio output by a second playback device may be adjusted relative to first audio output by a first playback device based on measured spectral variation in the sound field due to the geometry and features of the listening environment. This variance or variation in the sound field may be determined or measured and adjusted for. Reducing the variance may involve outputting one or more signals that reverse negative effects, so that the sound field is closer or matches an expected sound field based on the audio that is to be reproduced. In other words, the media playback system may be configured to apply adjustments that change an observed frequency response within a room to be closer to an expected frequency response.

In these examples, the method may include determining a frequency response of the listening environment. The frequency response may comprise an impulse response of the listening environment, which may be referred to as a room impulse response, or RIR. The frequency response may be determined based on a plurality of measurements of a sound field across the listening environment. The sound field may be an actual sound field in the listening environment or a virtual sound field within a model of the listening environment. A sound field may be generated using the media playback system. The sound field may be generated by playing back audio via the first playback device. The sound field may be generated by playing back the audio via at least the second playback device or by playing back an adjusted version of the audio via at least the second playback device. The adjusted version may be determined based on an adjustment, comprising, initially, a preliminary adjustment or an initial state. The frequency response may be determined based on sampling the sound field at a plurality of locations within the listening environment. The plurality of locations may be randomly selected. The plurality of locations may be locations at which one or more microphones are positioned. For example, each playback device may include a microphone, and the plurality of locations may comprise or consist of the locations of the microphones of the playback devices.

A spatial variance may be determined based on the frequency response. The spatial variance may indicate a deviation of frequency responses across a frequency range, such as a standard deviation. The frequency range may comprise low frequencies. The frequency range may have a lower bound of 20 Hz, 30 Hz, 40 Hz, 50 Hz, 60 Hz, 70 Hz, 80 Hz, or 90 Hz. The frequency range may have an upper bound of 100 Hz, 150 Hz, 200 Hz, 250 Hz, or 300 Hz.

The spatial variance may be used to determine an adjustment for playback of audio by the second playback device, relative to the playback of audio by the first playback device, or to change a preliminary adjustment for playback of audio by the second playback device. The adjustment may comprise a frequency-dependent phase shift. The adjustment may comprise applying or updating parameters associated with at least one all-pass filter to the first audio data to produce the second audio data. Two or more all-pass filters may be applied to the first audio data to produce the adjustment for the second audio data. An all-pass filter may change the relative phases of frequencies without altering the gain of respective frequencies. The all-pass filter may be a second order all-pass filter. Accordingly, by changing the relative phases of different frequencies, particular effects such as constructive or destructive interference may be compensated for. As a result of applying such a phase shift, a desired output may be achieved across the frequency spectrum, and an improved listening experience may be provided for a listener or user. The above process may be performed iteratively, using an optimizer to improve the adjustment.

For determining the frequency response, a model of the listening environment may be generated. The model may comprise a two-dimensional model. In some examples, height information may be determined using the one or more sensors. Height information may be determined by playing back audio data through one or more upward-facing transducers, such that the audio data is reflected off a ceiling of the listening environment and the reflection is received by one or more microphones at a playback device or another device of the media playback system. Height information may also be determined using one or more other sensors. The height information may be used to determine a three-dimensional model of the listening environment. A three-dimensional model may enable three dimensional sound fields to be determined and for room modes relating to height dimensions to be determined. The model may be used to determine the adjustment.

According to aspects of the invention, the above method may be applied by a media playback system comprising one or more processors and memory storing instructions that, when performed by the one or more processors, cause the system to implement the above method. According to aspects of the invention, there may be provided one or more tangible, non-transitory computer-readable media storing instructions that, when executed by one or more processors of a media playback system, cause the media playback system to perform the above method.

Many of the details, dimensions, angles and other features shown in the Figures are merely illustrative of particular examples of the disclosed technology. Accordingly, other examples can have other details, dimensions, angles and features without departing from the spirit or scope of the disclosure. In addition, those of ordinary skill in the art will appreciate that further examples of the various disclosed technologies can be practiced without several of the details described below.

These and other features described herein improve upon earlier-developed systems and methods including, for example the systems and methods disclosed and described in the following earlier-filed patent applications assigned to Sonos, Inc.

U.S. application Ser. No. 13/083,499 titled “Multi-channel pairing in a media system”, filed Apr. 8, 2011 and issued on Jul. 22, 2014 as U.S. Pat. No. 8,788,080 discloses, among other features, configuring playback devices in home theater bonded zones to change equalization of speaker drivers and to optimize synchronization between paired devices.

U.S. application Ser. No. 13/466,877 titled “Methods and systems for subwoofer calibration”, filed May 8, 2012 and issued on Dec. 20, 2016 as U.S. Pat. No. 9,524,098 discloses, among other features, methods of subwoofer calibration and configuration, including equalizing individual subwoofers based on user preferences.

U.S. application Ser. No. 14/731,119 titled “Dynamic bonding of playback devices”, filed Jun. 4, 2015 and issued on Jan. 9, 2018 as U.S. Pat. No. 9,864,571 discloses, among other features, sharing playback devices among different zones and adjusting audio configurations dependent on the playback devices in the zones.

U.S. application Ser. No. 15/630,214 titled “Immersive audio in a media playback system”, filed Jun. 22, 2017 and issued on Jul. 17, 2018 as U.S. Pat. No. 10,028,069 discloses, among other features, using a secondary, auxiliary zone for playback of certain audio, and using devices in a primary zone to calibrate devices in the auxiliary zone.

However, none of the aforementioned earlier-filed applications, individually or in combination, disclose the particular combinations of features and functions shown and described herein that relate to playing back audio across two different playback devices where one playback device's audio is adjusted relative to the other based on a determined distance or dimension such as an acoustic path length.

The entire contents of U.S. application Ser. Nos. 13/083,499; 13/466,877; 14/731,119; and 15/630,214 are incorporated herein by reference.

### II. Suitable Operating Environment

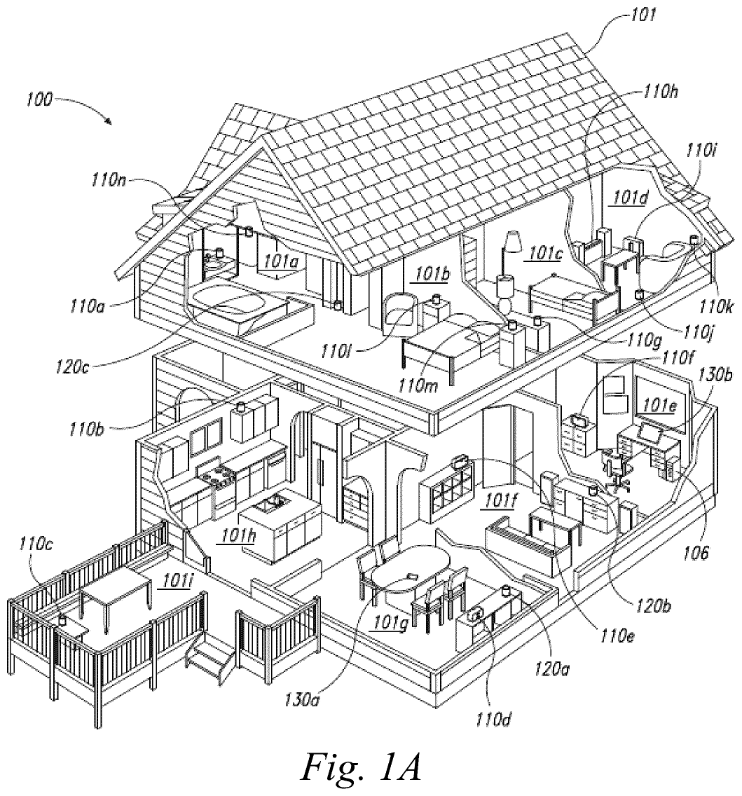

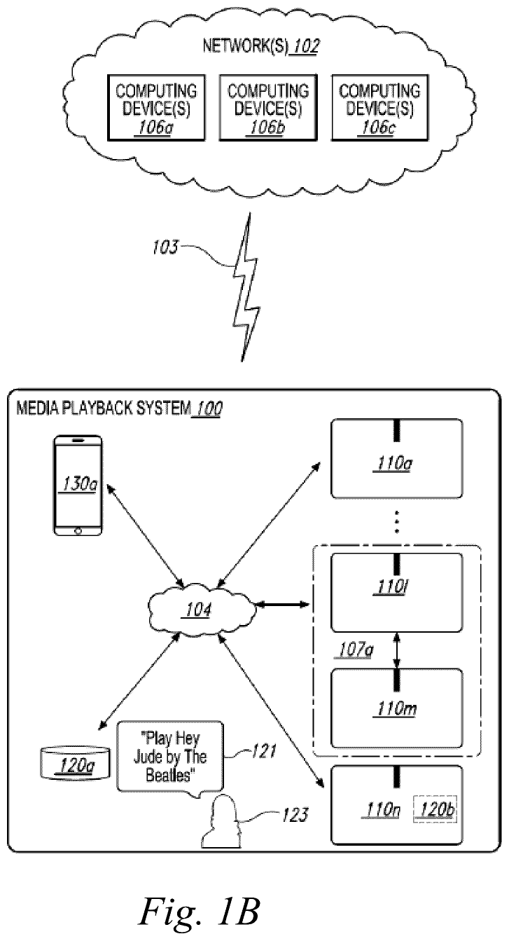

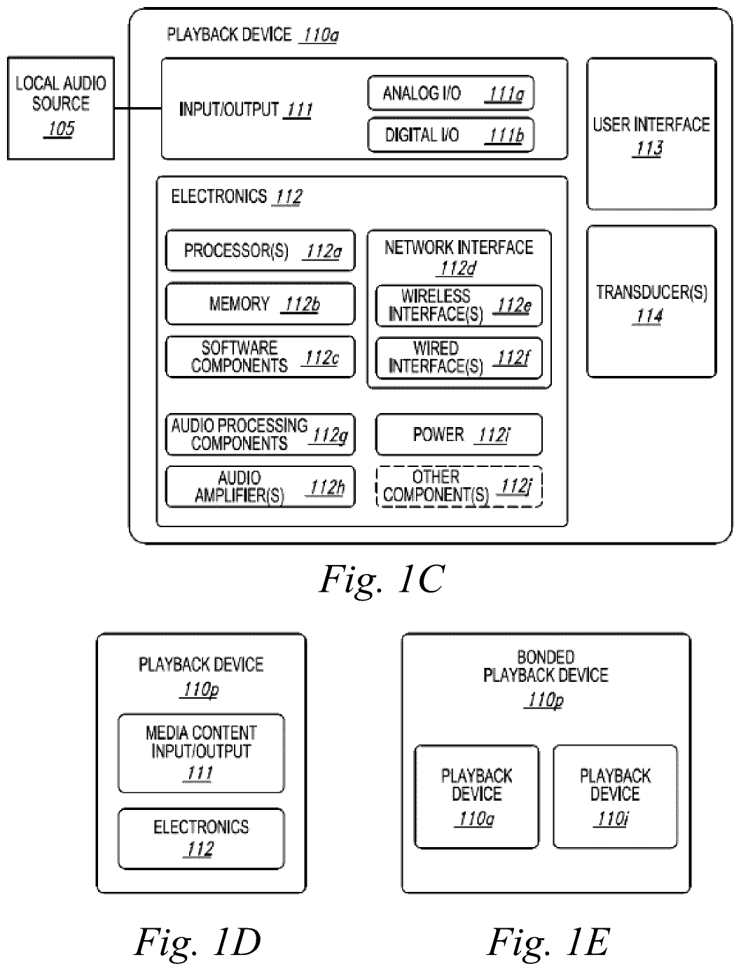

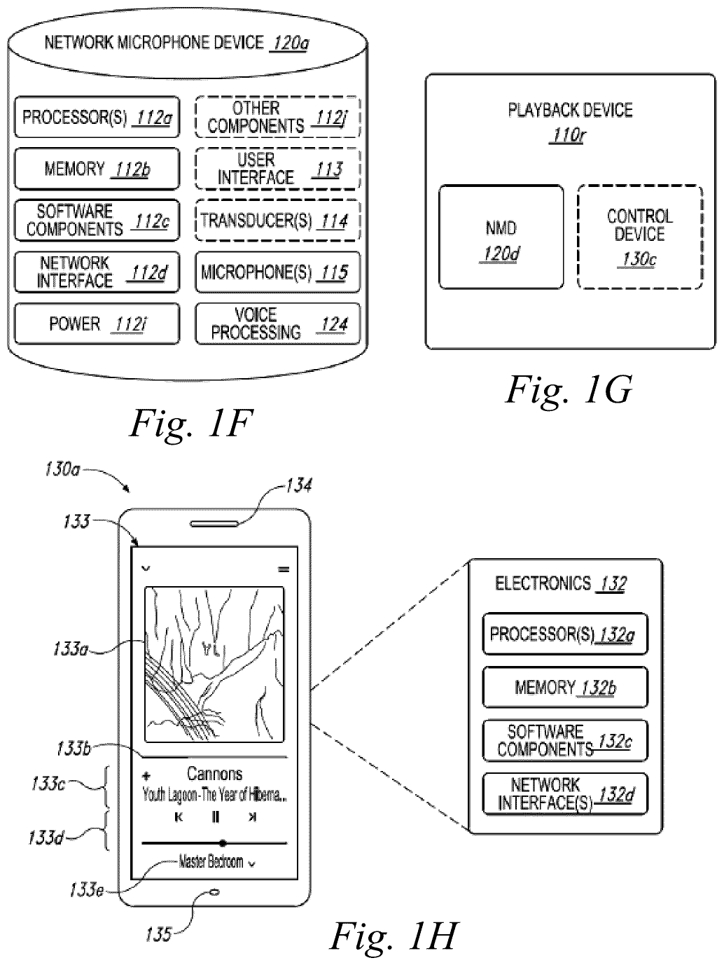

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some examples, a playback device includes one or more transducers or speakers powered by one or more amplifiers. In other examples, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some examples, an NMD is a stand-alone device configured primarily for audio detection. In other examples, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain examples, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some examples, for instance, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various examples of the disclosure are described in greater detail below.

In the illustrated example of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain examples and examples are described below in the context of a home environment, the technologies described herein may be implemented in other types of environments. In some examples, for instance, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable. Each room, space, or playback zone other than the patio 101i is bounded by a ceiling. Ceiling characteristics may differ between rooms, spaces, or playback zones.

The media playback system 100 can comprise one or more playback zones, some of which may correspond to the rooms in the environment 101. Each of the playback zones and/or the individual rooms may be referred to as a listening environment. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some examples, a single playback zone may include multiple rooms or spaces. In certain examples, a single room or space may include multiple playback zones.

In the illustrated example of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some examples, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some examples, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated by reference above.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some examples, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some examples, one or more of the computing devices 106 comprise modules of a single computer or server. In certain examples, one or more of the computing devices 106 comprise one or more modules, computers, and/or servers. Moreover, while the cloud network 102 is described above in the context of a single cloud network, in some examples the cloud network 102 comprises a plurality of cloud networks comprising communicatively coupled computing devices. Furthermore, while the cloud network 102 is shown in FIG. 1B as having three of the computing devices 106, in some examples, the cloud network 102 comprises fewer (or more than) three computing devices 106.

The media playback system 100 may be configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11 g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some examples, the network 104 comprises a dedicated communication network that the media playback system 100 uses to transmit messages between individual devices and/or to transmit media content to and from media content sources (e.g., one or more of the computing devices 106). In certain examples, the network 104 is configured to be accessible only to devices in the media playback system 100, thereby reducing interference and competition with other household devices. In other examples, however, the network 104 comprises an existing household communication network (e.g., a household WiFi network). In some examples, the links 103 and the network 104 comprise one or more of the same networks. In some examples, for instance, the links 103 and the network 104 comprise a telecommunication network (e.g., an LTE network, a 5G network). Moreover, in some examples, the media playback system 100 is implemented without the network 104, and devices comprising the media playback system 100 can communicate with each other, for example, via one or more direct connections, PANs, telecommunication networks, and/or other suitable communication links.

In some examples, audio content sources may be regularly added or removed from the media playback system 100. In some examples, for instance, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some examples, for instance, the media content database is stored on one or more of the playback devices 110, network microphone devices 120, and/or control devices 130.

In the illustrated example of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain examples, for instance, the group 107a comprises a bonded zone in which the playback devices 110l and 110m comprise left audio and right audio channels, respectively, of multi-channel audio content, thereby producing or enhancing a stereo effect of the audio content. In some examples, the group 107a includes additional playback devices 110. In other examples, however, the media playback system 100 omits the group 107a and/or other grouped arrangements of the playback devices 110.

The media playback system 100 of FIG. 1B includes the NMDs 120a and 120d, each comprising one or more microphones configured to receive voice utterances from a user. In the illustrated example of FIG. 1B, the NMD 120a is a standalone device and the NMD 120d is integrated into the playback device 110n. The NMD 120a, for example, is configured to receive voice input 121 from a user 123. In some examples, the NMD 120a transmits data associated with the received voice input 121 to a voice assistant service (VAS) configured to (i) process the received voice input data and (ii) transmit a corresponding command to the media playback system 100. In some examples, for instance, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110. Although the media playback system 100 is shown as including a plurality of playback devices 110a-110n, an NMD 120a, a control device 130a, and a network 104, in other examples the media playback system 100 may include one playback device incorporating an upward-firing transducer and one or more microphones, as well as a processor and memory stored at, for example, the playback device, a network microphone device, or a control device.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some examples, the analog I/O 111a is an audio line-in input connection comprising, for example, an auto-detecting 3.5 mm audio line-in connection. In some examples, the digital I/O 111b comprises a Sony/Philips Digital Interface Format (S/PDIF) communication interface and/or cable and/or a Toshiba Link (TOSLINK) cable. In some examples, the digital I/O 111b comprises a High-Definition Multimedia Interface (HDMI) interface and/or cable. In some examples, the digital I/O 111b includes one or more wireless communication links comprising, for example, a radio frequency (RF), infrared, WiFi, Bluetooth, or another suitable communication protocol. In certain examples, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some examples, the local audio source 105 includes local music libraries on a smartphone, a computer, a networked-attached storage (NAS), and/or another suitable device configured to store media files. In certain examples, one or more of the playback devices 110, NMDs 120, and/or control devices 130 comprise the local audio source 105. In other examples, however, the media playback system omits the local audio source 105 altogether. In some examples, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The one or more transducers may include further upward-firing transducers and/or a horizontal-firing transducer. The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. The playback device 110a includes one or more microphones 115 (hereinafter referred to as “the microphones 115”). The microphones 115 may comprise a plurality of microphones, and may be arranged as a microphone array. The microphone array may be an asymmetrical microphone array. In certain examples, for instance, the playback device 110a having the microphones 115 can operate as an NMD configured to receive voice input from a user and correspondingly perform one or more operations based on the received voice input.

In the illustrated example of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some examples, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some examples, the operations further include causing the playback device 110a to send audio data to another one of the playback devices 110a and/or another device (e.g., one of the NMDs 120). Certain examples include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some examples, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some examples, for instance, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated example of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some examples, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain examples, the network interface 112d includes the wired interface 112f and excludes the wireless interface 112e. In some examples, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some examples, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain examples, one or more of the audio processing components 112g can comprise one or more subcomponents of the processors 112a. In some examples, the electronics 112 omits the audio processing components 112g. In some examples, for instance, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some examples, for instance, the amplifiers 112h include one or more switching or class-D power amplifiers. In other examples, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain examples, the amplifiers 112h comprise a suitable combination of two or more of the foregoing types of power amplifiers. Moreover, in some examples, individual ones of the amplifiers 112h correspond to individual ones of the transducers 114. In other examples, however, the electronics 112 includes a single one of the amplifiers 112h configured to output amplified audio signals to a plurality of the transducers 114. In some other examples, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some examples, the transducers 114 can comprise a single transducer. In other examples, however, the transducers 114 comprise a plurality of audio transducers. In some examples, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain examples, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “MOVE,” “PLAY:5,” “BEAM,” “PLAYBAR,” “PLAYBASE,” “PORT,” “BOOST,” “AMP,” and “SUB.” Other suitable playback devices may additionally or alternatively be used to implement the playback devices of example examples disclosed herein. Additionally, one of ordinary skilled in the art will appreciate that a playback device is not limited to the examples described herein or to SONOS product offerings. In some examples, for instance, one or more playback devices 110 comprises wired or wireless headphones (e.g., over-the-ear headphones, on-ear headphones, in-ear earphones). In other examples, one or more of the playback devices 110 comprise a docking station and/or an interface configured to interact with a docking station for personal mobile media playback devices. In certain examples, a playback device may be integral to another device or component such as a television, a lighting fixture, or some other device for indoor or outdoor use. In some examples, a playback device omits a user interface and/or one or more transducers. For example, FIG. 1D is a block diagram of a playback device 110p comprising the input/output 111 and electronics 112 without the user interface 113 or transducers 114.

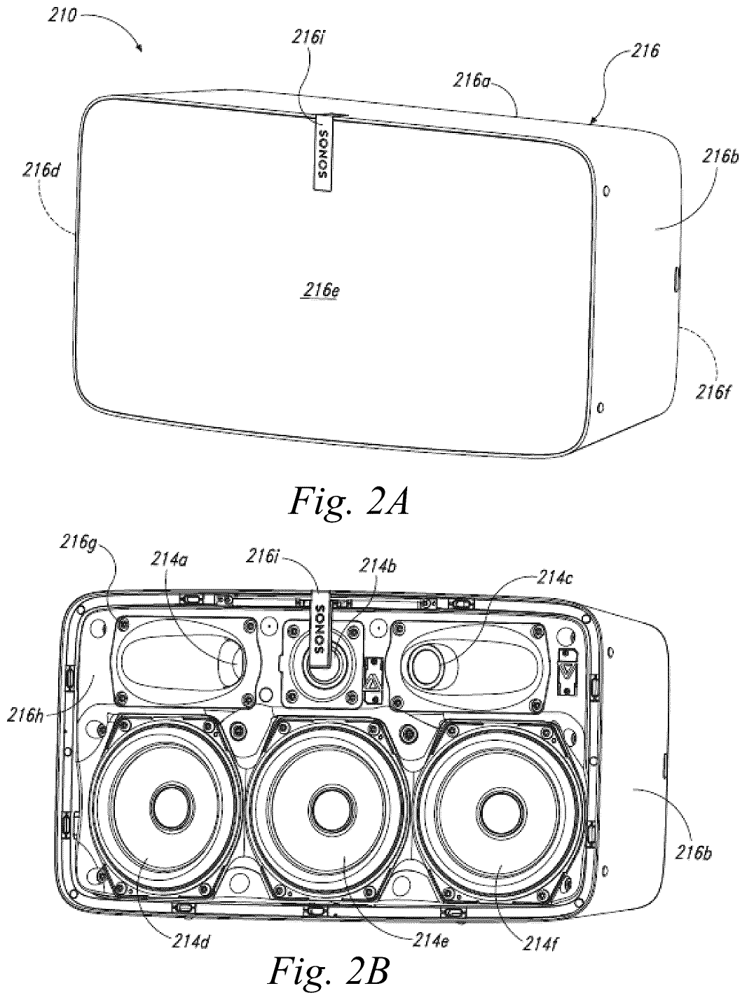

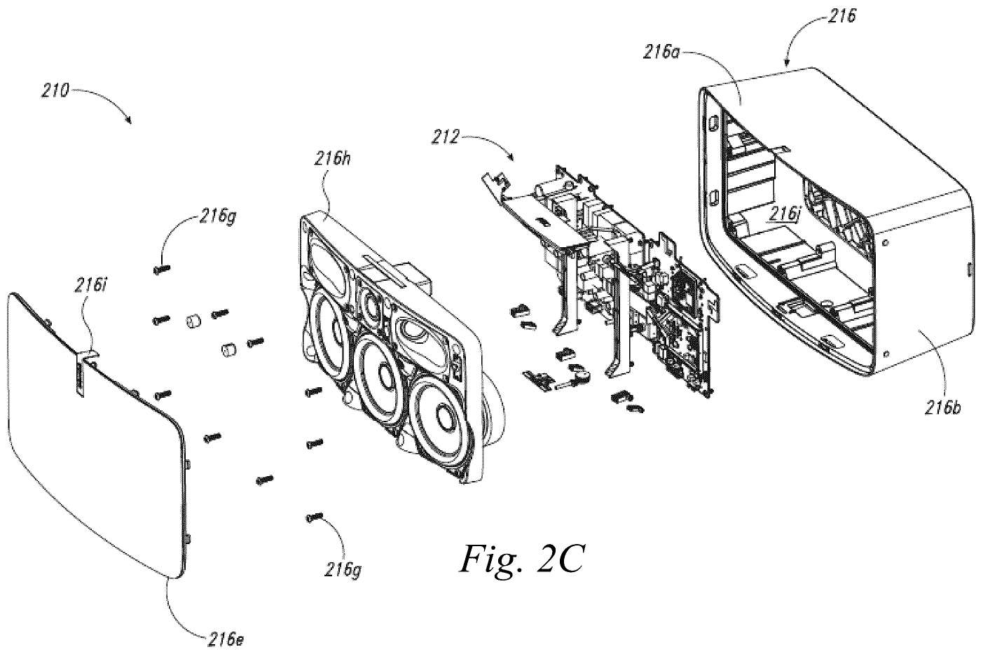

FIG. 1E is a block diagram of a bonded playback device 110q comprising the playback device 110a (FIG. 1C) sonically bonded with the playback device 110i (e.g., a subwoofer) (FIG. 1A). In the illustrated example, the playback devices 110a and 110i are separate ones of the playback devices 110 housed in separate enclosures. In some examples, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some examples, for instance, the playback device 110a is full-range playback device configured to render low frequency, mid-range frequency, and high frequency audio content, and the playback device 110i is a subwoofer configured to render low frequency audio content. In some examples, the playback device 110a, when bonded with the first playback device, is configured to render only the mid-range and high frequency components of a particular audio content, while the playback device 110i renders the low frequency component of the particular audio content. In some examples, the bonded playback device 110q includes additional playback devices and/or another bonded playback device. Additional playback device examples are described in further detail below with respect to FIGS. 2A-2C.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115, the software components 112c, the network interface 112d, and power 112i. The NMD 120a optionally comprises other components also included in the playback device 110a (FIG. 1C), such as the user interface 113 and/or the transducers 114, as well as other components 112j. In some examples, the NMD 120a is configured as a media playback device (e.g., one or more of the playback devices 110), and further includes, for example, one or more of the audio components 112g (FIG. 1C), the amplifiers 114, and/or other playback device components. In certain examples, the NMD 120a comprises an Internet of Things (IoT) device such as, for example, a thermostat, alarm panel, fire and/or smoke detector, etc. In some examples, the NMD 120a comprises the microphones 115, the voice processing components 124, and only a portion of the components of the electronics 112 described above with respect to FIG. 1B. In some examples, for instance, the NMD 120a includes the processor 112a and the memory 112b (FIG. 1B), while omitting one or more other components of the electronics 112. In some examples, the NMD 120a includes additional components (e.g., one or more sensors, cameras, thermometers, barometers, hygrometers).

In some examples, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other examples, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated example, the control device 130a comprises a smartphone (e.g., an iPhone™, an Android phone) on which media playback system controller application software is installed. In some examples, the control device 130a comprises, for example, a tablet (e.g., an iPad™), a computer (e.g., a laptop computer, a desktop computer), and/or another suitable device (e.g., a television, an automobile audio head unit, an IoT device). In certain examples, the control device 130a comprises a dedicated controller for the media playback system 100. In other examples, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some examples, the network interface 132d is configured to operate according to one or more suitable communication industry standards (e.g., infrared, radio, wired standards including IEEE 802.3, wireless standards including IEEE 802.11a, 802.11b, 802.11 g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130 to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others.

The user interface 133 is configured to receive user input and can facilitate ‘control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated example, the user interface 133 comprises a display presented on a touch screen interface of a smartphone (e.g., an iPhone™, an Android phone). In some examples, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some examples, the one or more speakers comprise individual transducers configured to correspondingly output low frequencies, mid-range frequencies, and/or high frequencies. In some examples, for instance, the control device 130a is configured as a playback device (e.g., one of the playback devices 110). Similarly, in some examples the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some examples, two or more of the microphones 135 are arranged to capture location information of an audio source (e.g., voice, audible sound) and/or configured to facilitate filtering of background noise. Moreover, in certain examples, the control device 130a is configured to operate as playback device and an NMD. In other examples, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Example Playback Devices

FIG. 2A is a front isometric view of a playback device 210 configured in accordance with examples of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some examples, the playback device 210 includes a number of transducers different than those illustrated in FIGS. 2A-2C. For example, the playback device 210 can include fewer than six transducers (e.g., one, two, three). In other examples, however, the playback device 210 includes more than six transducers (e.g., nine, ten). Moreover, in some examples, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated example of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some examples, however, the playback device 210 omits the filter 216i. In other examples, the playback device 210 includes one or more additional filters aligned with the transducers 214b and/or at least another of the transducers 214.

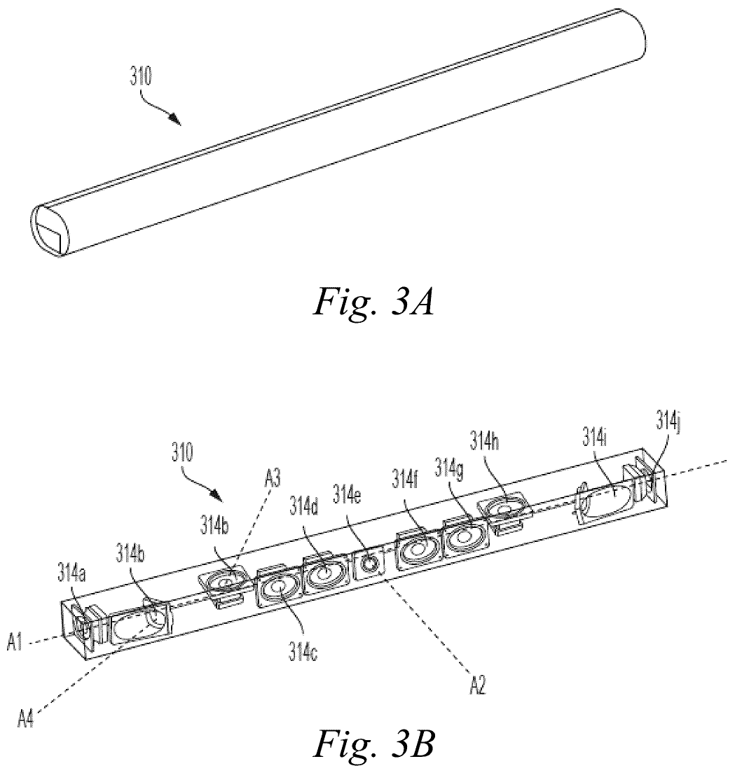

FIG. 3A is a perspective view of a playback device 310, and FIG. 3B shows the device 310 with the outer body drawn transparently to illustrate the plurality of transducers 314a-j therein (collectively “transducers 314”). The transducers 314 can be similar or identical to any one of the transducers 214a-f described previously. In this example, the playback device 310 takes the form of a soundbar that is elongated along a horizontal axis A1 and is configured to face along a primary sound axis A2 that is substantially orthogonal to the first horizontal axis A1. In other examples, the playback device 310 can assume other forms, for example having more or fewer transducers, having other form-factors, or having any other suitable modifications with respect to the example shown in FIGS. 3A and 3B. In various implementations, the playback device 310 can serve as a home theatre primary playback device, and may be placed in a center front position of a home theatre listening environment. In such a configuration, the playback device 310 can play back home theatre audio synchronously with playback via one or more satellite playback devices, which can be arranged about the listening environment in a suitable configuration. Additional details regarding home theatre audio playback can be found, for example, in U.S. Patent Application No. 63/377,897 entitled, “Home Theatre Audio Playback With Multichannel Satellite Playback Devices,” which is incorporated herein by reference in its entirety.

The playback device 310 can include individual transducers 314a-j oriented in different directions or otherwise configured to direct sound along different sound axes. For example, the transducers 314c-g can be configured to direct sound primarily along directions parallel to the primary sound axis A2 of the playback device 310, and may be referred to as horizontal, forward-firing transducers. Additionally, the playback device 310 can include left and right upward-firing transducers (e.g., transducers 314b and 314h) that are configured to direct sound along axes that are angled vertically with respect to the primary sound axis A2. For example, the left upward-firing transducer 314b is configured to direct sound along the axis A3, which is vertically angled with respect to the horizontal primary axis A2. In some examples, the upward-firing sound axis A3 can be angled with respect to the primary sound axis A2 by between about 50 degrees and about 90 degrees, between about 60 degrees and about 80 degrees, or about 70 degrees.

The playback device 310 can optionally include one or more horizontal, side-firing transducers (e.g., transducers 314a, 314b, 314i, and 314j), which can direct sound along axes that are horizontally angled with respect to the primary sound axis A2. In the illustrated example, the outermost transducers 314a and 314j can be configured to direct sound primarily along the first horizontal axis A1 or at least partially horizontally angled therefrom, while the side-firing transducers 314b and 314i are configured to direct sound along an axis that lies between the axes A1 and A2. For example, the left side-firing transducer 314b is configured to direct sound along axis A4.

In playback devices that do not have such side-firing transducers, side-propagating audio can be achieved by use of arrays, in which the audio output by each transducer sums in manner that the combined output has a directivity and is oriented along a side-propagating axis.

In operation, the playback device 310 can be utilized to play back 3D audio content that includes a vertical component (also referred to herein as a “height component”). As noted previously, certain 3D audio or other immersive audio formats include one or more height channels in addition to any lateral (e.g., left, right, front) channels. Examples of such 3D audio formats include DOLBY ATMOS, MPEG-H, and DTS:X formats. In playback devices that do not have such upward-firing transducers, upward-propagating audio can be achieved by use of arrays, in which the audio output by each transducer sums in a manner that the combined output has a directivity and is oriented along a vertically propagating axis.

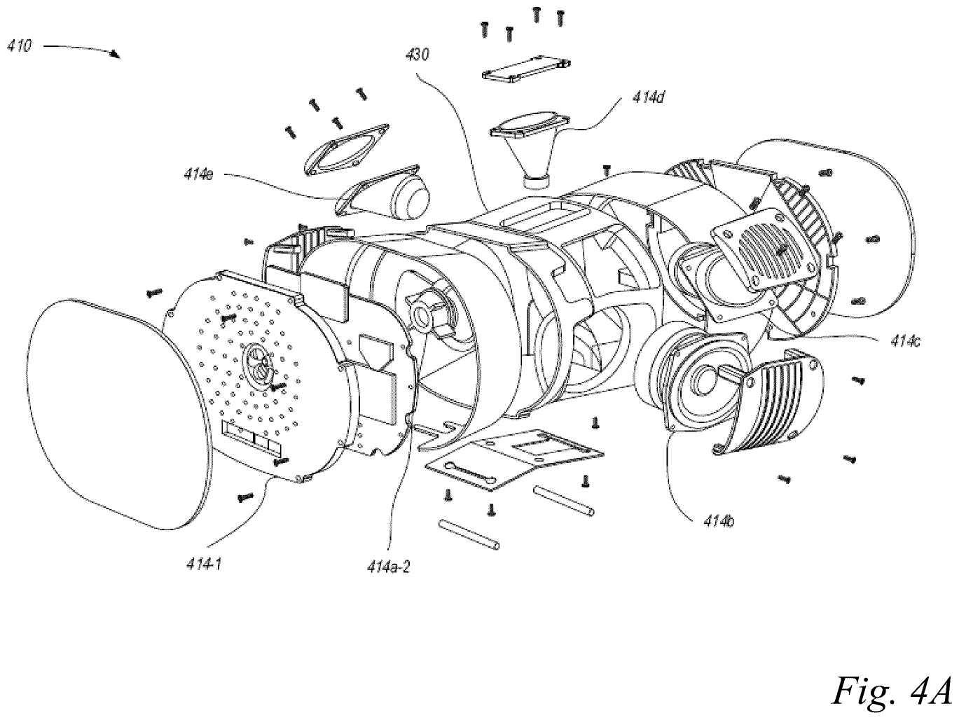

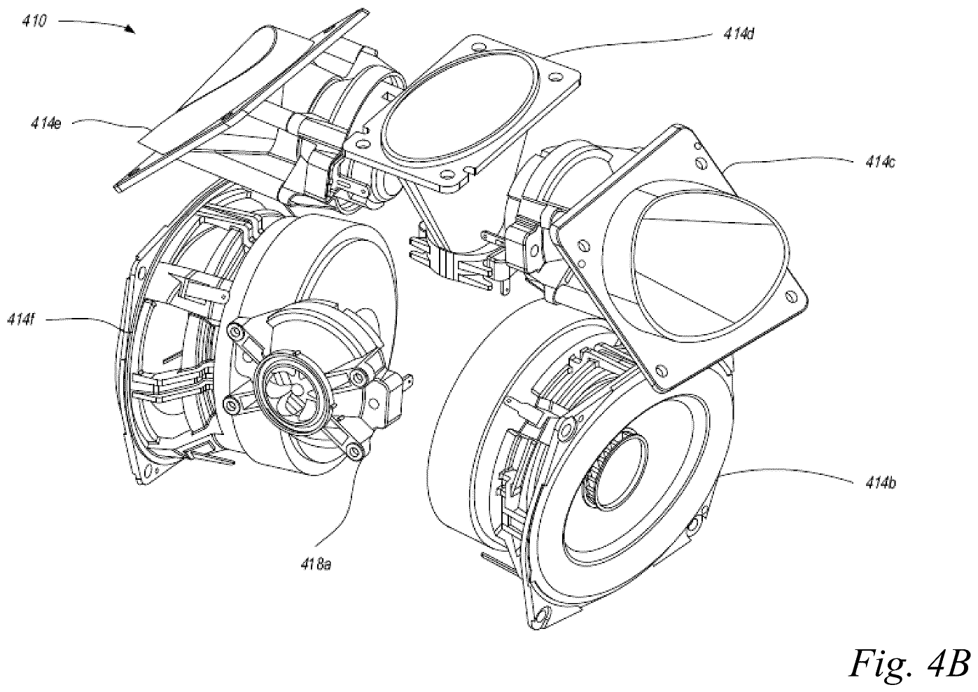

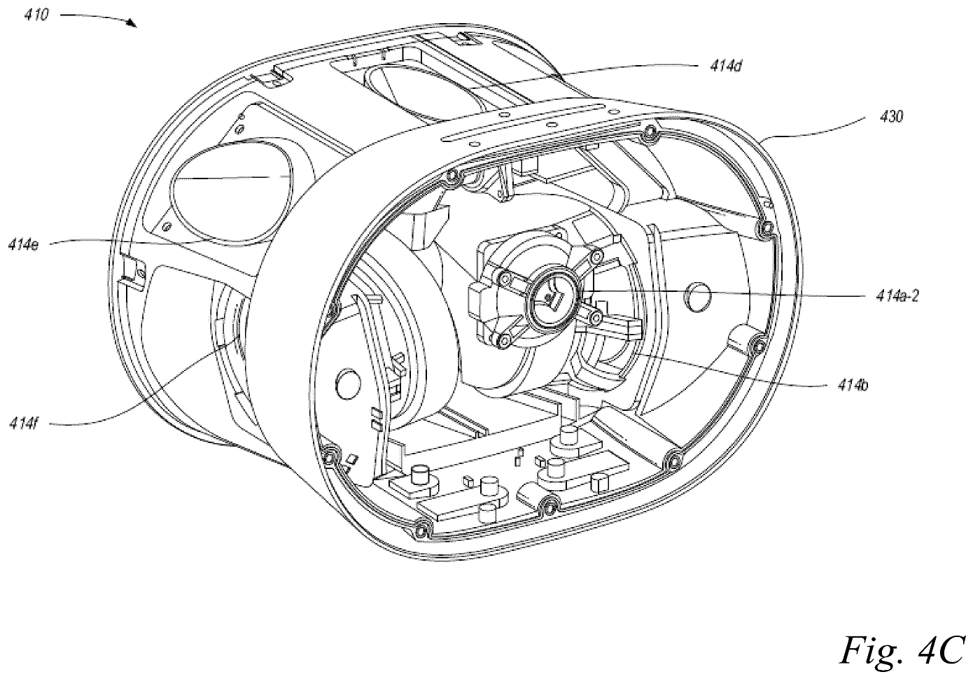

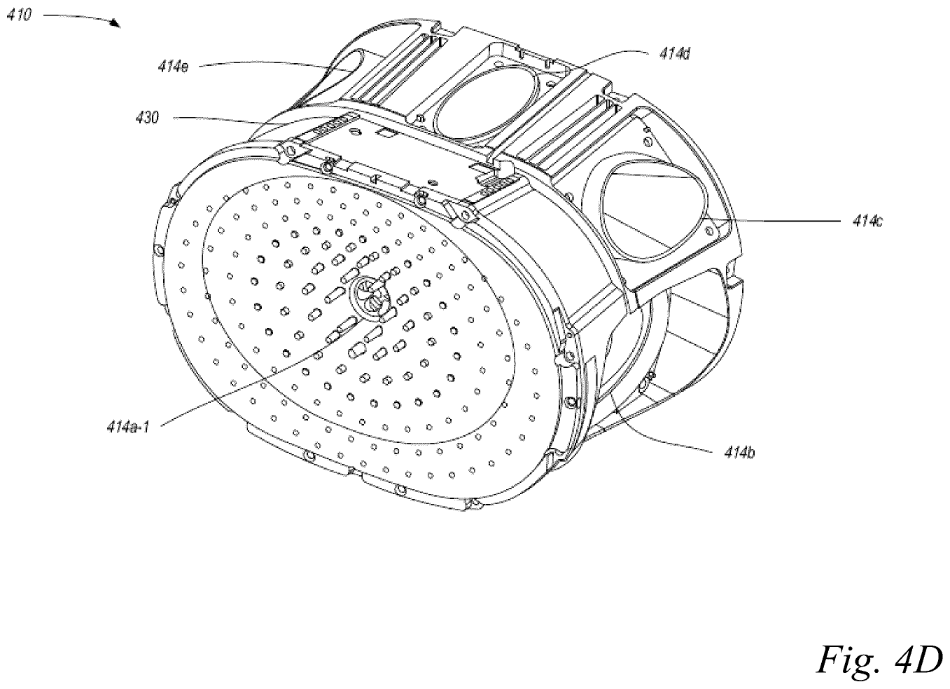

In example implementations, various techniques described herein may be carried out with a playback device that includes multiple audio transducers, and may optionally be used as a multichannel satellite playback device for home theatre applications. By way of illustration, FIG. 4A is an exploded view of a playback device 410 that includes a plurality of speakers 414. In particular, the speakers 414 include a forward firing transducer 414a, a side-firing transducer 414b, a side-firing transducer 414c, an upward-firing transducer 414d, a side-firing transducer 414e, and a side-firing transducer 414f (not shown). The speakers 414 are carried in a housing 430. The playback device 410 may otherwise include components the same as or similar to the playback devices 110a (FIG. 1C), 210 (FIG. 2A) or 310 (FIG. 3A), which may be carried by the housing 430.

As shown in the exploded view of FIG. 4A, the forward-firing transducer 414a is comprised of several components, including a first component 414a-1 and a second component 414a-b. In assembly, the first component 414a-1 and the second component 414a-b are joined to form the forward-firing transducer 414a. In other examples, the side-firing transducer 414a may be formed from a single component. Within example implementations, the other speakers 414 as well as the other components may be formed from one or more multiple components as well.

Within examples, the speakers may have a particular arrangement relative to one another. FIG. 4B is a partial view of the playback device 410 which illustrates the speakers 414 in an example arrangement. As shown, the forward firing transducer 414a is oriented in a first direction (i.e., forward). The side-firing transducer 414b and the side-firing transducer 414f are implemented as respective woofers and are oriented in second and third directions that are approximately 1800 from one another and approximately 90° from the first direction in the horizontal plane.

In this example, three of the speakers 414 are implemented as tweeters. These include the side-firing transducer 414c and the side-firing transducer 414e, which are similarly oriented as the side-firing transducer 414b and the side-firing transducer 414b. The tweeters also include the upward-firing transducer 414d, which is oriented in a fourth direction approximately 70° from the first direction in the vertical plane. As shown, the side-firing transducer 414c, the side-firing transducer 414e, the upward-firing transducer 414d also include respective horns.

The arrangements of the speakers 414 may have particular acoustic effects. For instance, the arrangement of the side-firing transducer 414c and the side-firing transducer 414e may provide an ambient effect when surround content is output via the side-firing transducer 414c and the side-firing transducer 414e respectively. The similar arrangement of the side-firing transducers 414b and the side-firing transducer 414f may have a similar effect. In contrast, the forward-firing transducer 414a has a relatively more direct sound (assuming that the playback device 410 is oriented such that the primary direction of output 414a is more oriented toward the user(s) relative to the primary direction of output of the side-firing transducers 414).

To provide further illustration, FIG. 4C is a view showing the playback device 410 as partially assembled. FIG. 4C shows the housing 430 carrying the side-firing transducer 414b, the upward-firing transducer 414d, the side-firing transducer 414e, and the side-firing transducer 414e, as well as the second component 414a-2 of the forward-firing transducer 414a. The first component 414a-1 is not shown in FIG. 4C in order to provide a partial interior view of the housing 430.

FIG. 4D is a further view showing the playback device 410 also as partially assembled (without the exterior speaker grilles and trim). FIG. 4D shows the housing 430 carrying the side-firing transducer 414b, the side-firing transducer 414c, the upward-firing transducer 414d, and the side-firing transducer 414e. In this view, the first component 414a-1 of the forward-firing transducer 414a is connected to the second component 414a-2.

### IV. Example Techniques for Improved Homogeneity of a Sound Field within a Listening Environment

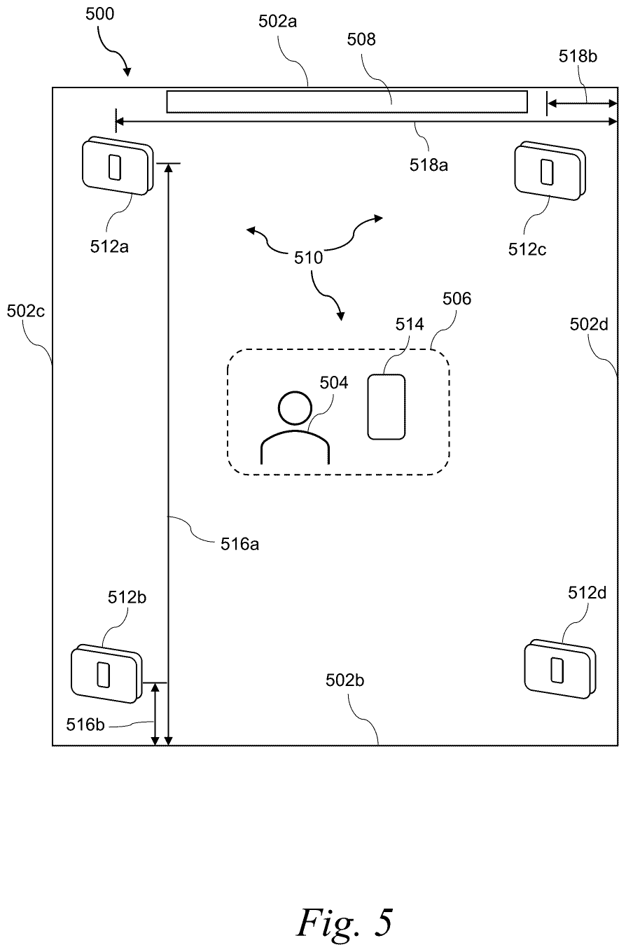

FIG. 5 shows a plan view illustrating how a media playback system may be configured and used to improve homogeneity of a sound field. In FIG. 5, a listening environment 500 is illustrated, defined by a front wall 502a, a rear wall 502b, a left wall 502c, and a right wall 502d. The walls are described in this example with reference to a listener 504 at a listener position 506 and facing the front wall 502a, where a screen 508 is positioned. The walls may be referred to, more simply, as first to fourth walls 502-d. The walls 502a-d are arranged so that the listening environment has a rectangular plan. Although not visible, the listening environment 500 may be defined by other walls or boundaries. The listening environment 500 may be substantially enclosed. In the example of FIG. 5, the walls 502a-d are flat for clarity of explanation. However, the present disclosure can be applied to walls and other boundaries that take any form and have any construction or material. The listening environment may be or comprise a room, space, or playback zone, such as those described in relation to FIG. 1A. The listening environment 500 may be a room, space, or playback zone, such as those shown in FIG. 1A and labelled 101a-101i.

A media playback system 510 is provided in the listening environment 500. The media playback system 510 comprises a first playback device 512a, a second playback device 512b, a third playback device 512c, and a fourth playback device 512d, that are each positioned in the listening environment 500. The playback devices 512a-d are subwoofers in FIG. 5. The playback devices 512a-d may have some or all of the features of the playback devices 110 as described in relation to FIGS. 1A to 1E and 1G.

The playback devices 512a-d are positioned in the corners of the listening environment 500. A playback device may be considered to be positioned in a corner by being closer to that corner than another playback device, within a predetermined distance from that corner, and/or adjacent the walls forming that corner. The first playback device 512a is provided in the corner between the front and left walls 502a, 502c; the first playback device 512a is adjacent the front wall 502a and is adjacent the left wall 502c. The second playback device 512b is provided in the corner between the rear and left walls 502b, 502c; the second playback device 512b is adjacent the rear wall 502b and is adjacent the left wall 502c. The third playback device 512c is provided in the corner between the front and right walls 502a, 502d; the third playback device 512c is adjacent the front wall 502a and is adjacent the right wall 502d. The fourth playback device 512d is provided in the corner between the rear and right walls 502b, 502d; the fourth playback device 512d is adjacent the rear wall 502b and is adjacent the right wall 502d. The playback devices 512a-d may be provided in the corners of the listening environment 500 for ease of positioning and/or to provide the widest coverage of the listening environment 500. The playback devices 512a-d may be at the same height or at different heights within the listening environment 500.

The media playback system 510 may also include a control device 514 belonging to and operated by the listener 504. The listener 504 may also be referred to as a user or viewer. The control device 514 may be present in the environment or external to the environment. The control device may have some or all of the features of the control device 130a as described in relation to FIGS. 1A, 1B, and 1H. In other examples, the media playback system 510 may include a network device, such as the network microphone device(s) 120a, 120b described in relation to FIGS. 1A, 1B, 1F, and 1G above.

The media playback system 510 further includes one or more sensors, although these are not visible in FIG. 5. In FIG. 5, the one or more sensors comprise one or more microphones provided at each playback device 512a-d. The playback devices 512a-d therefore each include at least one transducer and at least one microphone. The media playback system 510 further includes at least one processor and memory comprising code or instructions for performance by the at least one processor. The at least one processor and memory may be provided at one or more of the playback devices 512a-d or at the control device.

The media playback system 510 may be configured to output audio data via the playback devices 512a-d. The audio data, which may be referred to as audio or an audio signal, may comprise a song or soundtrack or other audio. The audio data may be output by the playback devices 512a-d, thereby to form a sound field within the listening environment 500. The media playback system 510 may be configured to output audio data to form a substantially homogenous sound field, such that when the listener 504 moves around the listening environment 500, variations are as imperceptible as possible.

To achieve such homogeneity, the media playback system 510 may be configured to perform one or more measurements of the listening environment 500. The media playback system 510 may be configured to determine at least one acoustic path length along the listening environment 500. In FIG. 5, a first acoustic path length is depicted along a length of the listening environment 500, including a first distance 516a from the first playback device 512a to the rear wall 502b and a second distance 516b from the rear wall 502b back to the second playback device 512b. At least the first playback device 512a may output a measurement audio signal at a first time and the first acoustic path length may be determined based on a time of arrival of the audio signal or a reflection thereof at one of the microphones in the listening environment. For example, the acoustic path length may be determined directly based on a reflection of the measurement audio signal from the rear wall being received at the microphone of the second playback device 512b, where the first acoustic path length may be determined based on the time of arrival at the second playback device 512b and the time of emission from the first playback device 512a. Alternatively, the acoustic path length may be determined in parts. As a first example, the acoustic path length may be determined in two portions, labelled 516a and 516b in FIG. 5. The first playback device 512a may be configured to receive at its microphone a reflection of its own measurement audio signal off the rear wall 502b and determine a distance between the first playback device 512a and the rear wall 502b based on a time of arrival of the reflection. The second playback device 512b may also be configured to output a signal to determine a distance between it and the rear wall 502b based on a reflection received at its microphone. In another example, the measurement audio signal may be received at the microphone of the second playback device 512b, and a distance between the first and second playback devices 512a, 512b may be determined. The second playback device 512b may again be configured to output a further measurement signal to determine the distance between it and the rear wall 502b based on a reflection.

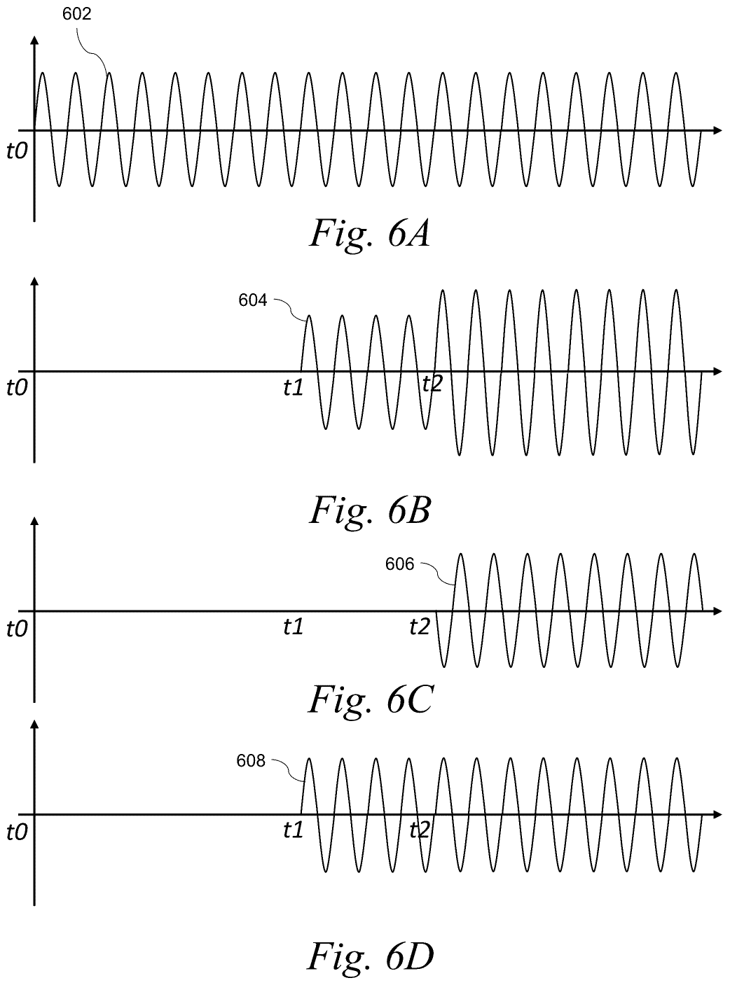

The acoustic path length may be used to determine adjustments for audio played back by the second playback device 512b and the fourth playback device 512d relative to audio played back by the first playback device 512a and the third playback device 512c. The adjustment may be determined to counteract or compensate for reflections of the audio played back by the first and third playback devices 512a, 512c from the rear wall 502b. During audio playback, the first and third playback devices 512a, 512c may be configured to output first audio data. The first audio data may be considered to be a plane wave that travels along the length of the listening environment 500 from the first and third playback devices 512a, 512c towards the rear wall 502b. When the plane wave reaches the rear wall 502b, it may be reflected. The reflection may cause interference as subsequent audio data travels along the listening environment 500 towards the rear wall 502b. The reflection may be compensated for by playing back second audio by the second and fourth playback devices 512b, 512d that is adjusted relative to the first audio. The second audio may comprise an inverted portion of the first audio, and may be delayed relative to the first audio. By inverting at least a portion of the first audio and playing that inverted portion back according to a delay, the reflection may be substantially cancelled, so that, in the region between the playback devices 512a-d, the sound field may be substantially homogenous. An example of delaying and inverting the first audio is illustrated in FIGS. 6A to 6D. Inverting the audio may be referred to as changing the polarity of the first audio.

The plane wave may be modelled along a length of the room, such that the playback devices 512a, 512c closest to the front wall 502a play back the first audio and the playback devices 512b, 512d closest to the rear wall 502b play back the second audio that is adjusted relative to the first audio. In other examples, the plane wave may be modelled across a width of the room. In these examples, the media playback system 510 may be configured to determine a second acoustic path length from the first playback device 512a. The second acoustic path length includes a first distance 518a from the first playback device 512a to the right wall 502d and a second distance 518b from the right wall 502d back to the third playback device 512c. Where the plane wave is modelled across the width of the room, the first playback device 512a and second playback device 512b may play back the first audio, and the third and fourth playback devices 512c, 512d may play back the second audio.

In some examples, both the first acoustic path length and the second acoustic path length may be determined. The media playback system may be configured based on the first and second acoustic path lengths. In an example, it may be determined which of the first and second acoustic path lengths is longer. Alternatively, other dimensions of the listening environment may be determined, such as a width and a length of the environment or a distance between the first playback device 512a and at least the rear wall 502b and the right wall 502d. A comparison may be made to determine a longest path length, distance, or dimension. The media playback system may be configured based on the comparison, so that the plane wave is modelled over the longest path length, distance or dimension. Applying such a comparison to the situation shown in FIG. 5, a determination would be made that the first acoustic path length is longer than the second acoustic path length, and therefore the first and third playback devices 512a, 512c are to be configured to play back the first audio and the second and fourth playback devices 512b, 512d are to be configured to play back the second audio that is adjusted relative to the first audio.

The above processes may be applied to listening environments having different arrangements, shapes, or dimensions, and using media playback systems having different numbers of playback devices. In some examples, the media playback systems may comprise playback devices other than subwoofers, such as the playback devices described in relation to FIGS. 2A to 4D above or as in FIGS. 1A-F. Four playback devices 512a-d are depicted in FIG. 5 but in other examples the media playback system may include two playback devices, three playback devices, or five or more playback devices. One or more microphones may be provided at one or more of the playback devices 512a-d, at the control device 514, or at a separate, network microphone device.

In FIG. 5, the sensors comprise microphones at the playback devices. Alternatively or additionally, the sensors may comprise a camera, a LiDAR detector, or another type of sensor. A camera or LiDAR detector may be used to determine one or more dimensions of the listening environment. The sensors, whether they are microphones or other types of sensor, may be used to generate a model of the environment. The model may be a two-dimensional model or a three-dimensional model.

FIGS. 6A to 6D provide a worked example of the above process. For clarity, only the first playback device 512a and the second playback device 512b are considered in relation to FIGS. 6A to 6D. Each of FIGS. 6A to 6D includes a chart. A first chart in FIG. 6A shows a first output audio signal 602 output by the first playback device 512a as a sine wave starting at time t0.

A second chart in FIG. 6B shows a first recorded audio signal 604 received by a microphone at the second playback device 512b if the second playback device 512b were to not play back any audio. As can be seen, at time t1, the audio output by the first playback device 512a is received. The audio output is reflected off the rear wall 502b and at t2 the reflection constructively interferes with the initial audio from the first playback device, causing a superposition such that a sine wave is produced having a higher amplitude than output by the first playback device 512a. In other examples, the reflection may cause destructive interference or a combination of constructive and destructive interference, depending on the wall 502b and other features of the listening environment 500. Accordingly, the time of flight of the first audio signal 602 along the first acoustic path length is t2-t0. For clarity, the first recorded audio signal 604 of FIG. 6B includes only the influence of the reflection from the rear wall 502b and does not show the influence of other reflections within the listening environment 500, such as reflections from side or front walls.

A third chart in FIG. 6C shows a second output audio signal 606 that may be output by the second playback device 512b to counteract the reflection from the rear wall 502b. As can be seen, the second output audio signal 606 is adjusted relative to the first output audio signal 602, because it is delayed by the time of flight of the first output audio signal 602 along the first acoustic path length, which is t2-t0, and it is an inverted version of the first output audio signal 602. Where other reflections within the listening environment 500 are present, the second playback device 512b may perform processing to distinguish the reflection from the rear wall 502b and to determine an appropriate second output signal 606.

A fourth chart in FIG. 6D shows a second recorded audio signal 608 received by the microphone at the second playback device 512b if the second playback device 512b were to play back the second output audio signal 606. As can be seen, between t1 and t2, the same sine wave is observed, and after t2, because of the playback of the second output audio signal 606, the same sine wave as the first output audio signal is also observed. Accordingly, the sound field created using the sine wave and by the media playback system including the first and second playback devices is more homogenous than without adjusting the playback of the second playback device. It should be noted that were the second playback device controlled to playback the first audio at a different amplitude and substantially synchronously with the first playback device, then the sound field would likely have less homogeneity due to reflections off the walls. As with FIG. 6B, for clarity, the second recorded audio signal 608 of FIG. 6D considers only the reflection from the rear wall 502b and the influence of the second output audio signal 606, and does not show the influence of other reflections within the listening environment 500, such as reflections from side or front walls.

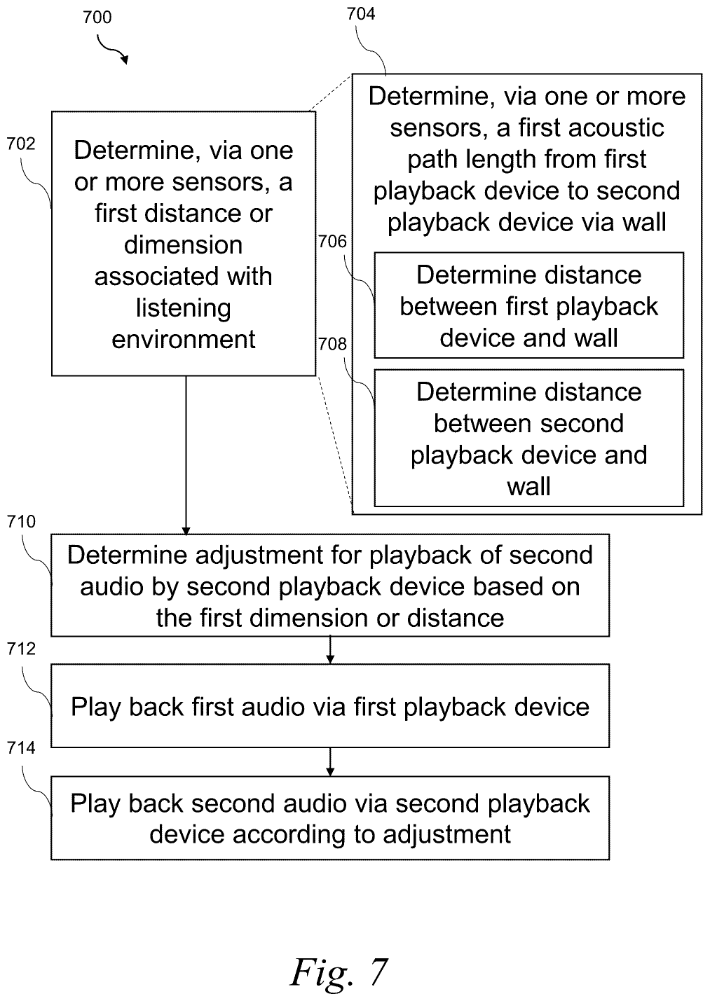

FIG. 7 illustrates a flow chart of a general method governing the process described above in relation to FIGS. 5 and 6. At a first step 702, the method 700 shown in FIG. 7 includes determining, via one or more sensors, such as the microphones or a camera, a first distance or dimension associated with the listening environment. As shown in the additional step 704, determining the first distance or dimension in step 702 may comprise determining a first acoustic path length from a first playback device to a second playback device via a wall adjacent the second playback device. The first playback device may be the first playback device 512a of FIG. 5 or another of the playback devices in FIG. 5. The second playback device may be the second playback device 512b of FIG. 5, such that the wall adjacent the second playback device is the rear wall 502b and the first acoustic path length is the acoustic path length of FIG. 5. The second playback device may be considered to be adjacent to a wall if it is closer to the wall than the first playback device along the first acoustic path length.

As part of step 704, determining the first acoustic path length may comprise determining a distance between the first playback device and the wall adjacent the second playback device as in step 706 and determining a distance between the second playback device and the wall adjacent the second playback device at step 708. As described above, these distances may be determined in several different ways. Accordingly, the first acoustic path length includes a distance travelled by sound from the first playback device to the wall, and a distance travelled by the sound as it is reflected off the wall and back to the second playback device. In step 704, the distance may be determined to be from a transducer or transducers of the first playback device to the wall, or from an outer surface of the first playback device closest to the wall. In step 706, the distance may be determined to be from the wall to a microphone or outer surface in which the microphone is mounted of the second playback device.

At step 710, having determined the first distance or dimension, the method 700 includes determining an adjustment for playback of second audio by the second playback device relative to playback of first audio by the first playback device. The adjustment is determined based on the first dimension or distance determined in step 702. In the process of FIG. 5, the adjustment may comprise a delay and/or an inversion relative to the first audio. The delay may comprise a delay time corresponding to or equal to a time of flight of sound travelling along the acoustic path length. Accordingly, step 710 may include determining a time of flight associated with the sound travelling along the acoustic path length, and determining the delay time based on the time of flight.

Subsequently, at steps 712 and 714, the first audio may be played back via the first playback device and the second audio may be played back via the second playback device according to the adjustment. Steps 712 and 714 may be performed substantially simultaneously, dependent on the amount of time delay introduced by the adjustment in step 714.

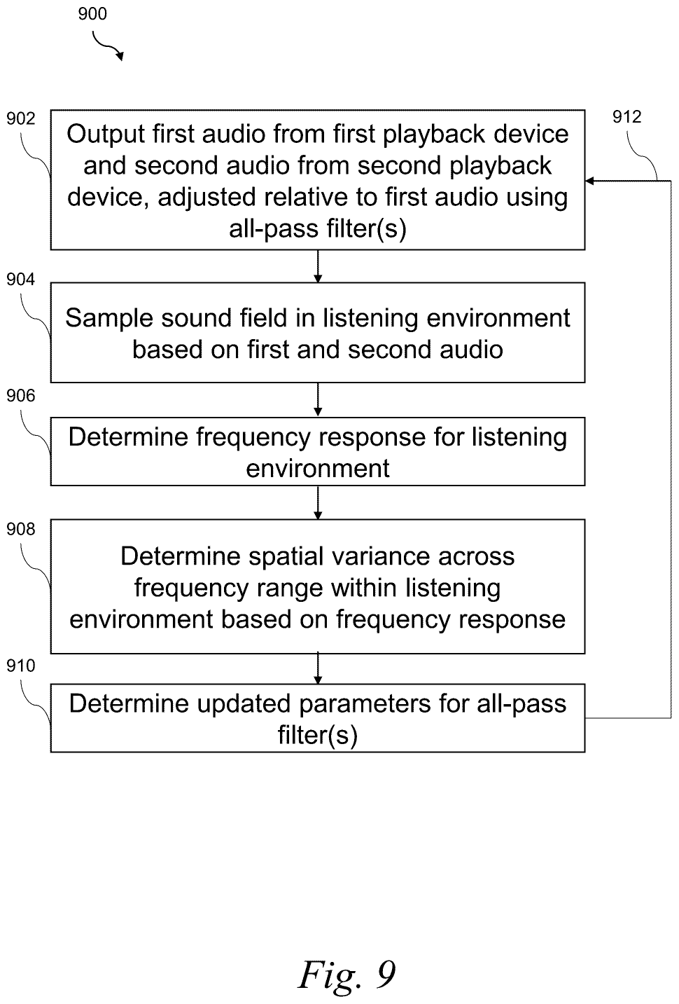

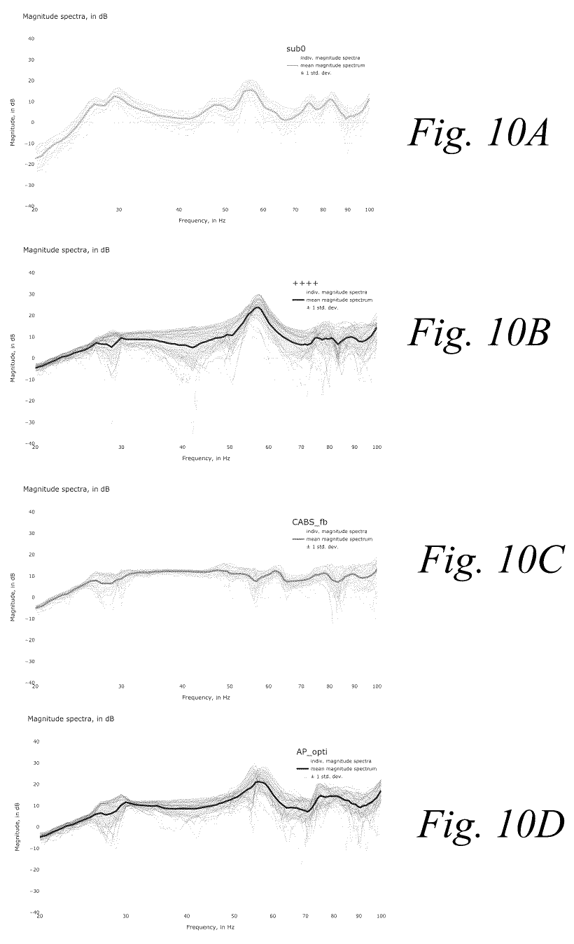

The methods described in relation to FIGS. 5 and 6 involve assuming that sound, particularly low frequency sound, travels as a plane wave along the listening environment, and so considers the main reflection that may cause interference, which is the reflection from a wall adjacent the second playback device. It may be useful to consider other reflections or effects caused by a listening environment, or to be able to compensate for such effects in a listening environment having a more complex geometry or arrangement. Such an approach, which can also be described by the method of FIG. 7, is described below in relation to FIGS. 9 and 10. In this approach, audio output by at least a second playback device may be adjusted relative to audio output by a first playback device based on a determined sound field, so as to counteract or compensate for determined variations in the sound field. Accordingly, the sound field may be considered to be static, and the approach may iteratively adjust the outputs of at least the second playback device to reduce the variation across the sound field.

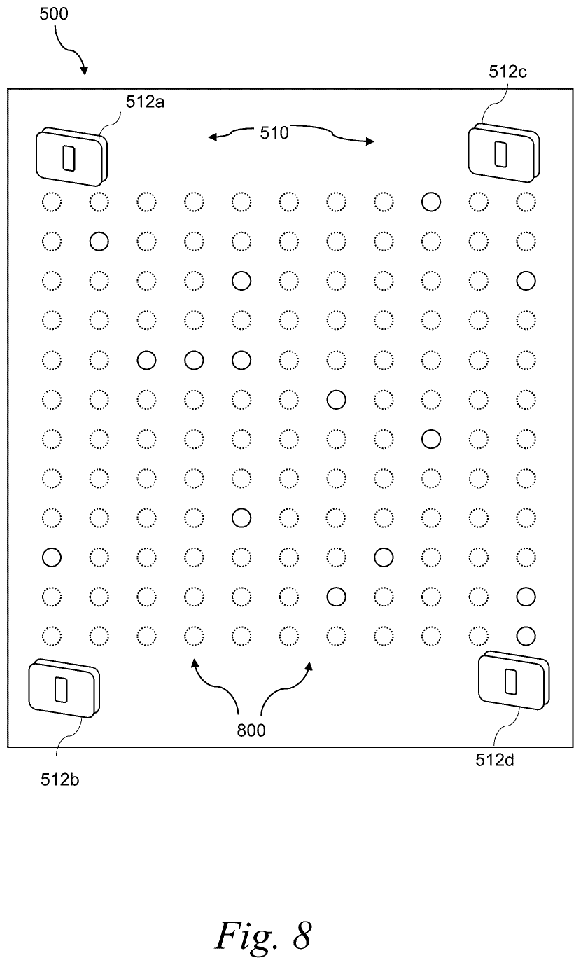

FIG. 8 shows the listening environment 500, which is the same listening environment as in FIG. 5. The listening environment 500 also includes the media playback system 510 as shown in FIG. 5, although the user and control device are excluded for clarity. FIG. 8 also includes a plurality of measurement locations 800. The measurement locations 800 are arranged in a grid between the playback devices 512a-d.

As described in the general method 700 of FIG. 7, the media playback system 510 may be configured to perform a method 700 including determining at least one distance or dimension and determining an adjustment for second audio relative to first audio for playback by a second playback device.

At least one distance or dimension may be determined, as in step 702. In FIG. 8, a dimension of the listening environment 500 may be determined or a distance between one or more of the playback devices 512a-d may be determined. The distance may be used to direct a user to position a playback device 512a-d at a particular location, or a particular distance from another playback device. In some examples, the distance or dimension may be used to determine the measurement locations 800 or to determine a model of the listening environment 800 for determination of the measurement locations 800. A model may be determined based on one or a plurality of dimensions. The distance or dimension(s) may be determined based on audio output from one or more playback devices and received by a microphone. The microphone may be at one of the playback devices or may be on a separate device. Alternatively, a camera or other image sensor may be used to determine the distance.

Subsequently, an adjustment may be determined as in step 710 of the method 700. FIG. 9 shows an example method 900 for determining the adjustment. Initially, referring to both FIGS. 8 and 9, a sound field may be generated in the listening environment 500, based on audio being output by the playback devices 512a-d. This is shown in FIG. 9 at step 902. Initially, the audio may be output according to an initial state based on a first playback device outputting first audio and the second, third, and fourth playback devices 512b-d outputting second, third, and fourth audio that is adjusted relative to the first audio using at least one filter for each playback device. The filter may be an all-pass filter. An all-pass filter may implement unity gain across all frequencies. An all-pass filter may introduce or implement a frequency-dependent phase shift or a frequency-dependent delay. The filter may be configured to have an initial set of parameters in the initial state. The parameters may be set such that, in the initial state, the second, third, and fourth audio is substantially the same as the first audio after passing through the respective filters. The parameters may include a center frequency, at which the phase is inverted, and a Q factor, being the frequency width of the phase inversion. In other examples, the first audio may be played back by each playback device, initially. The adjustment may comprise a frequency-dependent phase shift. In other examples, a frequency-dependent phase-shift may use a mechanism other than an all-pass filter, such as by using a different kind of filter that implements a frequency-dependent phase shift as well as implementing frequency shifts or a different phase-shifting circuit.

The sound field for the listening environment 500 generated by the playback devices 512a-d in the initial state may be sampled at a subset of the measurement locations 800, as indicated at step 904 of FIG. 9. The subset may be randomly selected from the measurement locations 800. In FIG. 8, an example subset of randomly selected measurement locations is marked using a solid line, whereas other, unselected measurement locations are indicated using a dotted line. Alternatively, rather than defining a plurality of measurement locations 800 in a regular arrangement and selecting from those locations, a set of measurement locations may initially be randomly located.

The sampling may be performed in the real listening environment, using microphones at each of the subset of measurement locations. If performed by a user, the user may be prompted to move a network microphone device to each of the measurement locations, and the sound field may be recreated while the device is at each location. The user may choose at least some of the measurement locations themselves. The network microphone device may be time-synchronized with the playback devices 512a-d, such that a position of the network microphone device may be confirmed or pinpointed relative to one or more of the playback devices 512a-d by utilizing time of flight measurements.

The sampling may be performed in the real listening environment using existing microphones at one or more playback devices. For example, the microphones at the playback devices 512a-d may be used to sample the sound field at the locations of the playback devices. Other playback devices in the media playback system 510 may also be used to perform the sampling. In some examples, one or more soundbars, ceiling-mounted speakers, or other playback devices may include one or more microphones for use in sampling the sound field.

The sampling may be performed in a model of the listening environment. As described above, a model of the listening environment may be determined by the media playback system utilizing the one or more sensors. For example, the playback devices 512a-d may be configured to output audio and time of flight of that audio may be utilized to determine distances between the devices and dimensions of the listening environment, using microphones at the playback devices as the one or more sensors. Alternatively, another sensor type, such as a camera or LiDAR sensor may be used to determine said dimensions and distances. The model may be two- or three-dimensional. The model may be a full or partial model of the listening environment.

Based on the sampled sound field, at step 906, the media playback system 510 may be configured to determine a frequency response of the listening environment at each of the subset of measurement locations, based on multiple inputs. A room impulse response may be determined for each of the subset of measurement locations, and the room impulse response for each location may be analyzed to determine a frequency response at that location. The frequency response may be limited to a particular frequency range, such as a low frequency range.

At step 908, the frequency response may be used to determine a spatial variance across the listening environment 500. The spatial variance may be determined across a frequency range. Determining the spatial variance may comprise determining a spatial standard deviation (SSD) over a frequency range. The SSD is defined as the standard deviation of the magnitude spectrum in dB, across the subset of measurement locations at which the sound field was sampled:

$$SSD [ k ] = {std}_{i} ( dB ( \vert {H}_{i} [ k ] \vert ) )$$

|Hᵢ| is the frequency magnitude spectrum at measurement location i and k is each frequency bin in the frequency range over which the SSD is to be evaluated.

The spatial variance may comprise an average spatial standard deviation (ASSD) within the frequency range from the lower bound frequency f_{lower} to the upper bound frequency fᵤₚₚₑᵣ which may be defined as:

$$ASSD = \frac{1}{{k}_{fUpper} - {k}_{fLower} + 1} {\sum }_{k = {k}_{fLower}}^{{k}_{fUpper}} SSD [ k ] .$$

The spatial variance may be determined to compensate for a linear spacing of the frequency bins, by weighting low frequencies more. The spatial variance may comprise a weighted average spatial deviation (WASSD), which can be written as:

$$WASSD = \frac{1}{{\sum }_{k = {k}_{20}}^{{k}_{100}} \frac{1}{{log}_{10} ( k )}} {\sum }_{k = {k}_{20}}^{{k}_{100}} \frac{1}{{log}_{10} ( k )} SSD [ k ] .$$

Alternatively to the above spatial standard deviations, the spatial variance may comprise a maximal deviation. The maximal deviation may be observed for each pair of magnitude spectra as each frequency is used to estimate the worst case variation which could be observed. It is given in dB and can be written as:

$$MSD [ k ] = {max}_{i} dB ( \vert {H}_{i} [ k ] \vert ) - {min}_{i} dB ( \vert {H}_{i} [ k ] \vert ) .$$

Similarly to WASSD, the weighted average maximal standard deviation (WAMSD) may also computed.

In FIGS. 8 and 9, once a spatial variance is determined, at step 910, the parameters of the all-pass filters associated with at least a second playback device, and, in FIG. 8, the third and fourth playback devices also may be updated to reduce the spatial variance.

As indicated by the arrow 912, the method may be iteratively repeated, such that the same process may be performed for a new sound field generated according to the updated parameters.

In some embodiments, when performing the above method utilizing a frequency dependent phase-shift to adjust at least the second audio relative to the first audio, step 702 may be omitted, and instead the method may involve steps 710 to 714 instead.

FIGS. 10A to 10D show charts for audio signals associated with the above methods utilizing a media playback system including four playback devices, such as the media playback system 510, provided in a listening environment having a substantially rectangular plan. Each chart shows individual magnitude spectra determined at a plurality of measurement locations, illustrated by the thinnest lines in each chart, a mean magnitude spectrum, indicated by the thick, solid line in each chart, and ±1 standard deviation around the mean magnitude spectrum, illustrated as an area around the mean magnitude spectrum line.

A first chart, shown in FIG. 10A, shows a frequency spectrum of a first audio signal played back by a first playback device.

A second chart, shown in FIG. 10B, illustrates a frequency spectrum of a sound field when all four playback devices are playing the first audio signal and in phase. As can be seen in FIG. 10B, there is a prominent peak at approximately 56 Hz, that is more prominent than when a single playback device is playing back the first audio. Elsewhere the spatial variations around 28 and 29 Hz are apparent, as is the dip at approximately 41 Hz.

FIG. 10C shows a third chart generated when the media playback system was controlled according to the processes described in relation to FIGS. 5 to 7. The peaks are less pronounced in this chart than in either of FIGS. 10A and 10B, leading to a flatter spectrum. Accordingly, spectral variation is reduced using this approach when compared to using a single playback device or a plurality of playback devices operating in phase and a more homogenous sound field has therefore been produced using this approach.

FIG. 10D shows a fourth chart generated where the adjustment is determined using all-pass filters for each playback device, as in FIGS. 8 and 9. While several peaks in the spectra still exist, the standard deviation across the frequency range is reduced when compared to the first and second chart in FIGS. 10A and 10B. As such, spatial variance has been reduced when compared to a single playback device playing back the first audio or a plurality of playback devices operating in phase, and a more homogenous sound field has been provided.

Although the processes described in relation to FIGS. 5 and 8 above are described separately, in some examples, they may be combined. Depending on the dimensions of the listening environment, or a measured sound field, a particular approach may be chosen for one or more playback devices. Accordingly, the homogeneity of the sound field may be dynamically improved in response to the listening environment. In such situations, a user interface may indicate to a user which approach is being used for example, by applying an indicator or a light.

### V. Conclusion

The above discussions relating to playback devices, controller devices, playback zone configurations, and media content sources provide only some examples of operating environments within which functions and methods described below may be implemented. Other operating environments and/or configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software examples or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “example” means that a particular feature, structure, or characteristic described in connection with the example can be included in at least one example of an invention. The appearances of this phrase in various places in the specification are not necessarily all referring to the same example, nor are separate or alternative examples mutually exclusive of other examples. As such, the examples described herein, explicitly and implicitly understood by one skilled in the art, can be combined with other examples.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain examples of the present disclosure can be practiced without certain, specific details. In other instances, well known methods, procedures, components, and circuitry have not been described in detail to avoid unnecessarily obscuring examples of the examples. Accordingly, the scope of the present disclosure is defined by the appended claims rather than the foregoing description of examples.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The disclosed technology is illustrated, for example, according to various examples described below. Various examples of examples of the disclosed technology are described as numbered examples (1, 2, 3, etc.) for convenience. These are provided as examples and do not limit the disclosed technology. It is noted that any of the dependent examples may be combined in any combination, and placed into a respective independent example. The other examples can be presented in a similar manner.

Example 1. A media playback system comprising: a first playback device; a second playback device positioned adjacent to a first wall; one or more sensors carried by at least one of the first playback device and the second playback device; one or more processors; memory storing instructions that, when executed by the one or more processors, cause the media playback system to: determine, via the one or more sensors, a first acoustic path length of sound propagating from the first playback device that is reflected from the first wall toward the second playback device, wherein determining the first acoustic path length comprises: determining a first distance between the first playback device and the first wall, and determining a second distance between the first wall and the second playback device; determine, based on the first acoustic path length, an adjustment for playback of second audio data via the second playback device with respect to playback of first audio data via the first playback device; play back the first audio data via the first playback device; and play back the second audio data via the second playback device according to the adjustment.

Example 2. The media playback system of any one of the preceding Examples, wherein determining the adjustment comprises determining a delay time associated with a time-of-flight of sound propagation corresponding to the first acoustic path length, and wherein playing back the second audio comprises delaying playback of the second audio data according to the determined delay time with respect to the playback of the first audio data via the first playback device.

Example 3. The media playback system of any one of the preceding Examples, further comprising determining, based on the first audio data, the second audio data, wherein determining the second audio data comprises inverting at least a portion of the first audio data.

Example 4. The media playback system of any one of the preceding Examples, wherein the adjustment is a first adjustment, the media playback system further comprising: a third playback device; and a fourth playback device positioned adjacent the first wall, wherein the instructions further cause the media playback system to: determine a second acoustic path length of sound propagating from the third playback device that is reflected from the first wall toward the fourth playback device; determine, based on the second acoustic path length, a second adjustment for playback of fourth audio data via the fourth playback device with respect to playback of third audio data via the third playback device; and play back the fourth audio data via the fourth playback device according to the second adjustment.

Example 5. The media playback system of any one of the preceding Examples, wherein the first, second, third, and fourth playback devices are subwoofers.

Example 6. The media playback system of any one of the preceding Examples, wherein determining the second acoustic path length comprises: determining a third distance between the third playback device and the fourth wall; and determining a fourth distance between the first wall and the fourth playback device.

Example 7. The media playback system of any one of the preceding Examples, wherein the instructions further cause the media playback system to: determine that the first playback device and the second playback device are arranged along a longest horizontal dimension of the listening environment, wherein the adjustment is determined based on determining that the first playback device and the second playback device are arranged along the longest horizontal dimension of the listening environment.

Example 8. The media playback system of any one of the preceding Examples, wherein determining, via the one or more sensors, the first acoustic path length comprises playing back third audio data from at least one of the first playback device or the second playback device.

Example 9. The media playback system of any one of the preceding Examples, wherein the first playback device comprises a first network interface and wherein the second playback device comprises a second network interface, and wherein the instructions, when executed by the one or more processors, cause the media playback system to: receive, via the first network interface, the first audio data; receive, via the second network interface, the first audio data; and apply, at the second playback device, the adjustment to the first audio data, thereby to generate the second audio data.

Example 10. The media playback system of any one of the preceding Examples, wherein at least one of the first playback device or the second playback device is a subwoofer.

Example 11. A method comprising: determining, via one or more sensors carried by at least one of a first playback device and a second playback device, a first acoustic path length of sound propagating from the first playback device that is reflected from a first wall toward the second playback device, wherein the second playback device is positioned adjacent to the first wall, and wherein determining the first acoustic path length comprises: determining a first distance between the first playback device and the first wall, and determining a second distance between the first wall and the second playback device; determining, based on the first acoustic path length, an adjustment for playback of second audio data via the second playback device with respect to playback of first audio data via the first playback device; playing back the first audio data via the first playback device; and playing back the second audio data via the second playback device according to the adjustment.

Example 12. One or more tangible, non-transitory computer-readable media storing instructions that, when executed by one or more processors of a media playback system, cause the media playback system to perform operations comprising: determining, via one or more sensors carried by at least one of a first playback device and a second playback device, a first acoustic path length of sound propagating from the first playback device that is reflected from a first wall toward the second playback device, wherein the second playback device is positioned adjacent to the first wall, and wherein determining the first acoustic path length comprises: determining a first distance between the first playback device and the first wall, and determining a second distance between the first wall and the second playback device; determining, based on the first acoustic path length, an adjustment for playback of second audio data via the second playback device with respect to playback of first audio data via the first playback device; playing back the first audio data via the first playback device; and playing back the second audio data via the second playback device according to the adjustment.

Example 13. A media playback system comprising: a first playback device; a second playback device; one or more sensors; one or more processors; memory storing instructions that, when executed by the one or more processors, cause the media playback system to: determine, via the one or more sensors, a distance between the first playback device and the second playback device; determine, based on the distance, an adjustment for audio playback by the second playback device relative to audio playback by the first playback device; playing back first audio data via the first playback device; and playing back second audio data via the second playback device according to the adjustment.

Example 14. The media playback system of any one of the preceding Examples, wherein the one or more sensors comprise one or more microphones, and wherein at least one of the first playback device or the second playback device comprises the one or more microphones, and wherein determining the distance comprises: playing back third audio data via at least the other of the first playback device or the second playback device; and receiving the third audio data via the one or more microphones, the distance being determined based on the third audio data.

Example 15. The media playback system of any one of the preceding Examples, wherein the first playback device comprises a first network interface and wherein the second playback device comprises a second network interface, and wherein the instructions, when executed by the one or more processors, cause the media playback system to: receive, via the first network interface, the first audio data; receive, via the second network interface, the first audio data; and applying, at the second playback device, the adjustment to the first audio data, thereby to generate the second audio data.

Example 16. The media playback system of any one of the preceding Examples, wherein the instructions, when executed by the one or more processors, cause the media playback system to: determine one or more dimensions of a listening environment in which the first playback device and the second playback device are located, wherein the adjustment is based on the one or more dimensions and wherein the one or more dimensions comprises at least one of: a distance between the first playback device and a boundary of the listening environment; a distance between the second playback device and a boundary of the listening environment; a distance between two boundaries of the listening environment; or an acoustic path length from the first playback device to the second playback device via one or more boundaries of the listening environment.

Example 17. The media playback system of any one of the preceding Examples, wherein the instructions, when executed by the one or more processors, cause the media playback system to: determine a model of the listening environment including the playback devices based on the one or more dimensions and the first distance, wherein the phase difference is based on the model.

Example 18. The media playback system of any one of the preceding Examples, wherein the adjustment comprises at least one of a delay or a change in polarity.

Example 19. The media playback system of any one of the preceding Examples, wherein the adjustment comprises a delay and the instructions, when executed by the one or more processors, cause the media playback system to: determine, based on the first distance and the one or more dimensions, that the first playback device and the second playback device are arranged along a longest horizontal dimension of the listening environment, wherein the delay is determined based on determining that the first playback device and the second playback device are arranged along the longest horizontal dimension of the listening environment.

Example 20. The media playback system of any one of the preceding Examples, wherein the adjustment comprises at least one of a frequency-dependent phase shift or applying at least one all pass filter.

1. A media playback system comprising:
a first playback device;
a second playback device positioned adjacent to a first wall;
one or more sensors carried by at least one of the first playback device and the second playback device;
one or more processors;
memory storing instructions that, when executed by the one or more processors, cause the media playback system to:
determine, via the one or more sensors, a first acoustic path length of sound propagating from the first playback device that is reflected from the first wall toward the second playback device, wherein determining the first acoustic path length comprises:
determining a first distance between the first playback device and the first wall, and
determining a second distance between the first wall and the second playback device;
determine, based on the first acoustic path length, an adjustment for playback of second audio data via the second playback device with respect to playback of first audio data via the first playback device;
play back the first audio data via the first playback device; and
play back the second audio data via the second playback device according to the adjustment.

2. The media playback system of claim 1, wherein determining the adjustment comprises determining a delay time associated with a time-of-flight of sound propagation corresponding to the first acoustic path length, and wherein playing back the second audio comprises delaying playback of the second audio data according to the determined delay time with respect to the playback of the first audio data via the first playback device.

3. The media playback system of claim 1, further comprising determining, based on the first audio data, the second audio data, wherein determining the second audio data comprises inverting at least a portion of the first audio data.

4. The media playback system of claim 1, wherein the adjustment is a first adjustment, the media playback system further comprising:
a third playback device; and
a fourth playback device positioned adjacent the first wall, wherein the instructions further cause the media playback system to:
determine a second acoustic path length of sound propagating from the third playback device that is reflected from the first wall toward the fourth playback device;
determine, based on the second acoustic path length, a second adjustment for playback of fourth audio data via the fourth playback device with respect to playback of third audio data via the third playback device; and
play back the fourth audio data via the fourth playback device according to the second adjustment.

5. The media playback system of claim 4, wherein the first, second, third, and fourth playback devices are subwoofers.

6. The media playback system of claim 4, wherein determining the second acoustic path length comprises:
determining a third distance between the third playback device and the fourth wall; and
determining a fourth distance between the first wall and the fourth playback device.

7. The media playback system of claim 4, wherein the instructions further cause the media playback system to:
determine that the first playback device and the second playback device are arranged along a longest horizontal dimension of the listening environment, wherein the adjustment is determined based on determining that the first playback device and the second playback device are arranged along the longest horizontal dimension of the listening environment.

8. The media playback system of claim 1, wherein determining, via the one or more sensors, the first acoustic path length comprises playing back third audio data from at least one of the first playback device or the second playback device.

9. The media playback system of claim 1, wherein the first playback device comprises a first network interface and wherein the second playback device comprises a second network interface, and wherein the instructions, when executed by the one or more processors, cause the media playback system to:
receive, via the first network interface, the first audio data;
receive, via the second network interface, the first audio data; and
apply, at the second playback device, the adjustment to the first audio data, thereby to generate the second audio data.

10. The media playback system of claim 1, wherein at least one of the first playback device or the second playback device is a subwoofer.

11. A method comprising:
determining, via one or more sensors carried by at least one of a first playback device and a second playback device, a first acoustic path length of sound propagating from the first playback device that is reflected from a first wall toward the second playback device, wherein the second playback device is positioned adjacent to the first wall, and wherein determining the first acoustic path length comprises:
determining a first distance between the first playback device and the first wall, and
determining a second distance between the first wall and the second playback device;
determining, based on the first acoustic path length, an adjustment for playback of second audio data via the second playback device with respect to playback of first audio data via the first playback device;
playing back the first audio data via the first playback device; and
playing back the second audio data via the second playback device according to the adjustment.

12. One or more tangible, non-transitory computer-readable media storing instructions that, when executed by one or more processors of a media playback system, cause the media playback system to perform operations comprising:
determining, via one or more sensors carried by at least one of a first playback device and a second playback device, a first acoustic path length of sound propagating from the first playback device that is reflected from a first wall toward the second playback device, wherein the second playback device is positioned adjacent to the first wall, and wherein determining the first acoustic path length comprises:
determining a first distance between the first playback device and the first wall, and
determining a second distance between the first wall and the second playback device;
determining, based on the first acoustic path length, an adjustment for playback of second audio data via the second playback device with respect to playback of first audio data via the first playback device;
playing back the first audio data via the first playback device; and
playing back the second audio data via the second playback device according to the adjustment.

13. A media playback system comprising:
a first playback device;
a second playback device;
one or more sensors;
one or more processors;
memory storing instructions that, when executed by the one or more processors, cause the media playback system to:
determine, via the one or more sensors, a distance between the first playback device and the second playback device;
determine, based on the distance, an adjustment for audio playback by the second playback device relative to audio playback by the first playback device;
playing back first audio data via the first playback device; and
playing back second audio data via the second playback device according to the adjustment.

14. The media playback system of claim 13, wherein the one or more sensors comprise one or more microphones, and wherein at least one of the first playback device or the second playback device comprises the one or more microphones, and wherein determining the distance comprises:
playing back third audio data via at least the other of the first playback device or the second playback device; and
receiving the third audio data via the one or more microphones, the distance being determined based on the third audio data.

15. The media playback system of claim 13, wherein the first playback device comprises a first network interface and wherein the second playback device comprises a second network interface, and wherein the instructions, when executed by the one or more processors, cause the media playback system to:
receive, via the first network interface, the first audio data;
receive, via the second network interface, the first audio data; and
applying, at the second playback device, the adjustment to the first audio data, thereby to generate the second audio data.

16. The media playback system of claim 13, wherein the instructions, when executed by the one or more processors, cause the media playback system to:
determine one or more dimensions of a listening environment in which the first playback device and the second playback device are located, wherein the adjustment is based on the one or more dimensions and wherein the one or more dimensions comprises at least one of:
a distance between the first playback device and a boundary of the listening environment;
a distance between the second playback device and a boundary of the listening environment;
a distance between two boundaries of the listening environment; or
an acoustic path length from the first playback device to the second playback device via one or more boundaries of the listening environment.

17. The media playback system of claim 16, wherein the instructions, when executed by the one or more processors, cause the media playback system to:
determine a model of the listening environment including the playback devices based on the one or more dimensions and the first distance, wherein the phase difference is based on the model.

18. The media playback system of claim 13, wherein the adjustment comprises at least one of a delay or a change in polarity.

19. The media playback system of claim 16, wherein the adjustment comprises a delay and the instructions, when executed by the one or more processors, cause the media playback system to:
determine, based on the first distance and the one or more dimensions, that the first playback device and the second playback device are arranged along a longest horizontal dimension of the listening environment, wherein the delay is determined based on determining that the first playback device and the second playback device are arranged along the longest horizontal dimension of the listening environment.

20. The media playback system of claim 13, wherein the adjustment comprises at least one of a frequency-dependent phase shift or applying at least one all pass filter.
